(19) United States
(12) Patent Application Publication
(10) Pub. No.: US 2025/0380101 A1
(43) Pub. Date: Dec. 11, 2025

(54) SPATIAL VOLUME CONTROL FOR ELECTRONIC DEVICES

(71) Applicant: Apple Inc., Cupertino, CA (US)

(72) Inventors: Camellia G. BOUTROS, San Francisco, CA (US); Deepak IYER, Mountain View, CA (US); Madhur AHUJA, Santa Clara, CA (US); Mitchell R. LERNER, San Francisco, CA (US); Sam D. SMITH, San Francisco, CA (US); Sanket S. DAVE, Sunnyvale, CA (US); Stephen E. PINTO, Mountain View, CA (US)

(21) Appl. No.: 19/195,633

(22) Filed: Apr. 30, 2025

Related U.S. Application Data
(60) Provisional application No. 63/657,723, filed on Jun. 7, 2024.

(51) Int. Cl. H04S 7/00

(52) U.S. Cl. CPC H04S 7/30; H04S 2400/13

(57) ABSTRACT

Aspects of the subject technology provide individual volume controls for concurrently operating audio sources at an electronic device. The audio sources may be spatialized audio sources that are associated with display objects that are displayed to appear at various three-dimensional locations around a user of the electronic device, such as in an extended reality environment. In this way, an electronic device may provide the user with the ability to individually control the volumes of the various audio streams originating from the various three-dimensional locations around the user. The individual volume controls may be applied according to individual volume control curves, and/or based on a user intent determined by the electronic device.

### CROSS REFERENCE TO RELATED APPLICATIONS

This application claims the benefit of priority to U.S. Provisional Patent Application No. 63/657,723, entitled, “Spatial Volume Control for Electronic Device”, filed on Jun. 7, 2024, the disclosure of which is hereby incorporated herein in its entirety.

### TECHNICAL FIELD

The present description relates generally to electronic devices, including, for example, to spatial volume control for electronic devices.

### BACKGROUND

Electronic devices such as smartphones and tablets typically display one user interface of one application at a time. If audio output is generated by the electronic device, the audio output is typically generated by the application for which the user interface is currently displayed, and volume of the output is typically controlled using a system volume control for the device. Some electronic devices, such as laptop computers and desktop computers can display multiple user interfaces of multiple applications at the same time at different places on a display screen. Similar to smartphones and tablets, even if multiple user interfaces generate multiple concurrent audio outputs from a single device, the volume of the multiple concurrent audio outputs is typically controlled using a single system volume control.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a block diagram of an example electronic device in accordance with one or more implementations.

FIG. 2 illustrates a rear perspective view of an example computer system for providing XR experiences in accordance with one or more implementations.

FIG. 3 illustrates an example of an extended reality environment including multiple user interfaces displayed, by an electronic device, to appear at multiple respective locations in a physical environment in accordance with aspects of the subject technology.

FIG. 4 illustrates a perspective view of the extended reality environment of FIG. 3 in accordance with one or more implementations.

FIG. 5 illustrates an example of an extended reality environment having user interfaces displayed at multiple distances in accordance with one or more implementations.

FIG. 6 illustrates an exemplary user interface for providing spatial volume control for a user in accordance with one or more implementations.

FIG. 7 illustrates examples of various volume control curves in accordance with one or more implementations.

FIG. 8 illustrates an example of a user moving a user interface between different perceived distances in accordance with one or more implementations.

FIG. 9 illustrates a block diagram of an example architecture for providing spatial volume control in accordance with one or more implementations.

FIG. 10 illustrates a block diagram of another example architecture for providing spatial volume control in accordance with one or more implementations.

FIG. 11 illustrates a flow diagram of example process for spatial volume control in accordance with one or more implementations.

FIG. 12 illustrates a flow diagram of another example process for spatial volume control in accordance with one or more implementations.

FIGS. 13A-B illustrate an example top-down architecture in accordance with one or more implementations.

FIG. 14 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

An electronic device may also include one or more components that generate sound. The sound-generating components can include components that generate the sound as a primary function of the component (e.g., speakers), and may also include components that generate sounds as a byproduct of the primary function of the component (e.g., fans, haptic components, motors, or other components with moving parts). In some cases, a sound-generating component may be a thermal management component, such as a fan or other air-moving component of the electronic device.

In one or more implementations, the speakers of an electronic device may be operated to generate one or more spatialized audio outputs that are perceived by a user of the electronic device as originating from one or more locations, remote from the speakers of the electronic device, within the physical environment of the electronic device. For example, the spatialized audio outputs may correspond with one or more user interfaces of one or more applications and/or system processes running at the electronic device. For example, the one or more user interfaces may be displayed, by one or more display components of the electronic device, to be visually perceived at the one or more locations from which the one or more spatialized audio outputs are perceived to originate. In this way, a user may be provided with a three-dimensional audio experience that coincides with three-dimensional visual experience being provided by the electronic device.

Providing the ability to display multiple user interfaces and multiple three-dimensional locations around the user (e.g., in an XR environment), with multiple spatialized audio outputs that also seem to originate from the multiple three-dimensional locations, opens the door to having multiple audio sources playing concurrently in a way that does not create the same type of audio conflict that would arise from multiple applications concurrently playing audio from the display of an smartphone, a tablet, a laptop, or a desktop computer with a display screen with limited two-dimensional area. For example, the audio experience of an XR environment can mimic the audio experience of a physical environment in which a user is working in one application on a computer in one location while music or other audio content plays from another device at another location. The spatial distribution of the sound sources in three dimensions around the user can allow the user to concentrate on a task at hand while, for example, paying background attention to one or more sound sources, as they would in a physical environment.

However, systems that provide spatially distributed audio with a singular main volume control for the electronic device can cause volume adjustments to all of the concurrent sound sources, which can include volume adjustments that are undesirable, unintuitive, and/or distracting to a user. As one illustrative example, a user may desire to turn down the volume of a music application, without turning down the volume of a remote user speaking in a conferencing application. As another illustrative example, a user may desire to turn down the volume of a gaming application in one spatial location, without turning down the volume of alerts and/or notification noises in a word processing application or messaging application. Thus, even with the spatial distribution of the sound sources being generated by the electronic device, it can be desirable for a user to have the ability to independently adjust the volumes of various sound sources and/or categories of sound sources. However, it can be challenging to implement individual or otherwise separate volume controls for multiple audio streams playing in a single mixed audio output from an electronic device.

System sounds, such as virtual clicks of a virtual keyboard, or masking sounds (e.g., sounds intended to mask the sound of a fan or other mechanical system component) can also be played concurrently with each other and/or with the audio from one or more applications. For example, sounds that are generated by fans or other components, for which the sound is a byproduct of the primary function of the component, can be distracting or annoying to users of electronic devices. Thus, it can also be desirable to mask, blur, or otherwise mitigate these mechanical sounds, at least in the perception of the user, even when other (e.g., user desired) sounds are being generated by the electronic device. Systems that provide spatially distributed audio with a singular main volume control for the electronic device can cause the volume of these system sounds to be undesirably raised, lowered, or muted when the volume of an application is raised, lowered, or muted. Accordingly, independent control of application volumes that is separate from the control of system volumes may also be desirable.

In one or more implementations, aspects of the subject technology can provide an architecture for providing separate volume controls for separate, concurrently active, audio sources at an electronic device. For example, in an extended reality environment, multiple applications, system features, alerts, environmental features, and/or video or avatars of remote users of other devices can be sources of sound that may be spatially distributed around a user of the electronic device at any given time. As discussed in further detail hereinafter, in order to provide the user with the ability to separately control the volume of these various sound sources, volume controls and/or other tunings may be applied to the various audio streams from the various sound sources (e.g., in parallel), prior to mixing of the audios streams into a final composite/mixed audio stream for output. Different volume curves (e.g., volume curves that describe volume output changes per various amounts of modification of a volume control interface, and/or that map a hardware volume curve to different software values) may be used for adjusting the volumes of different sound sources and/or different categories of sound sources. In one or more implementations, sensor signals from one or more sensors of the electronic device may be used to determine a user intention associated with an input corresponding to an audio volume change, and the electronic device may adjust the volume of one or more sound sources (e.g., differently from the way in which the sound sources would be adjusted in a physical environment) based on the determined user intention and based on the input corresponding to the audio volume change.

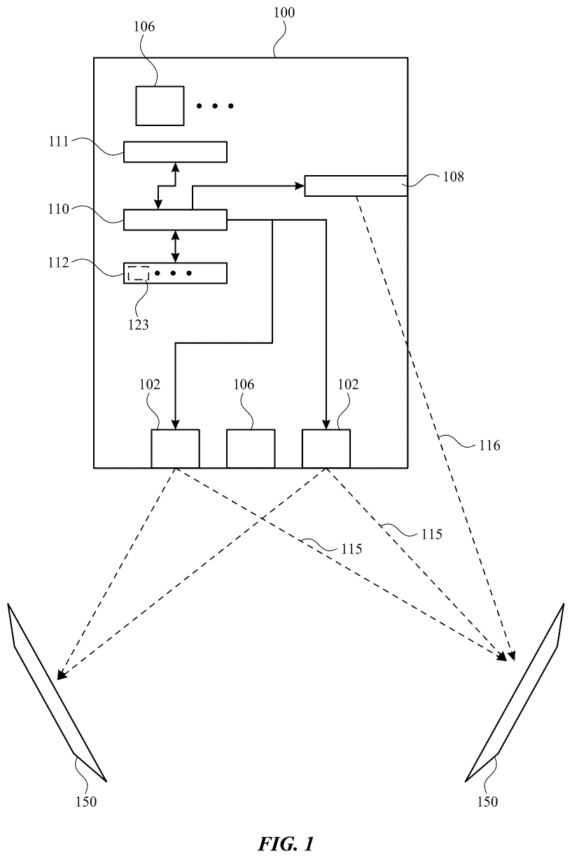

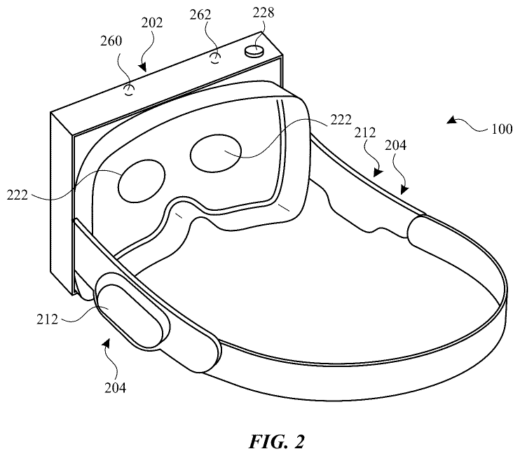

FIG. 1 illustrates an example electronic device in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example of FIG. 1, an electronic device 100 includes multiple speakers, such as speakers 102. Speakers 102 may each be configured to generate sound as a primary function of the speaker. Although two speakers 102 and a single sound-generating component 108 arc shown in FIG. 1, it is appreciated that the electronic device 100 may include one, two, three, more than three, or generally any number of speakers and/or sound-generating components.

As shown in FIG. 1, the electronic device may also include one or more sound-generating components, such as a sound-generating component 108. The sound-generating component 108 may be, for example, a thermal management component such as a fan (e.g., a cooling fan), a haptic component (e.g., a piezoelectric actuator), a motor, or any other device that generates sound as an unintended audio output (e.g., as a byproduct of the primary function of the component). As shown in FIG. 1, electronic device 100 may also include one or more microphones, such as microphones 106. Although two microphones are shown in FIG. 1, it is appreciated that the electronic device 100 may include two, three, more than three, or generally any number of microphones.

In the example of FIG. 1, the speakers 102 and the microphones 106 are disposed in a common housing with the processing circuitry 110, the memory 112, and the sound-generating component 108. In other implementations, some or all of the speakers 102 and/or some or all of the microphones 106 may be disposed in one or more separate housings from the housing in which the processing circuitry 110, the memory 112, and the sound-generating component 108. In one illustrative example, the speakers 102 may be disposed in headphones or earbuds that are communicatively coupled (e.g., via a wired or wireless connection) with the processing circuitry 110, the memory 112, and the sound-generating component 108. In another illustrative example, additional speakers that are disposed in headphones or earbuds may be communicatively (e.g., via a wired or wireless connection) with the processing circuitry 110.

In one or more implementations, the electronic device 100 may include one or more input sensors, such as input sensor 111. As examples, input sensor 111 may be or include one or more cameras, one or more depth sensors, one or more touch sensors, one or more device-motion sensors, one or more sensors for detecting and/or mapping one or more user physical characteristics (e.g., a Head Related Transfer Function or HRTF), one or more sensors for detecting one or more movements, and/or user gestures, such as hand gestures, one or more sensors for detecting features and/or motions of one or both eyes of a user, such as sensors for tracking a gaze location at which the user of the electronic device is gazing (e.g., a location within a user interface), and/or one or more sensors for detecting and/or mapping one or more environmental physical features of a physical environment around the electronic device 100 (e.g., for generating a three-dimensional map of the physical environment).

Electronic device 100 may be implemented as, for example, a portable computing device such as a laptop computer, a smartphone, a peripheral device (e.g., a digital camera, headphones), a tablet device, a smart speaker, a wearable device such as a watch, a band, a headset device, wired or wireless headphones, one or more wired or wireless carbuds (or any in-car, against the car or over-the-car device), and/or the like, or any other appropriate device (e.g., a desktop computer, a set-top box, a content streaming device, or the like) that includes one or more sound-generating components.

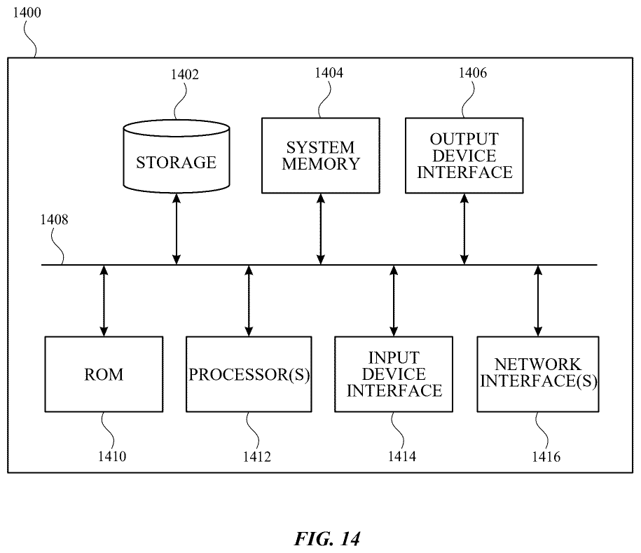

Although not shown in FIG. 1, electronic device 100 may include one or more wireless interfaces, such as one or more near-field communication (NFC) radios, WLAN radios, Bluetooth radios, Zigbee radios, cellular radios, and/or other wireless radios. Electronic device 100 may be, and/or may include all or part of, the electronic system discussed below with respect to FIG. 14.

In the example of FIG. 1, processing circuitry 110 of the electronic device 100 is operating the speakers 102 to generate sound 115 that is received at one or both cars 150 of a user of the electronic device 100. For example, the sound 115 may include audio content generated by one or more audio sources running at the electronic device 100 (e.g., on the processing circuitry 110). For example, the audio sources may include a media player application that generates an audio stream with audio content corresponding to music, a podcast, an audio track corresponding to video content (as examples). The audio sources may include other applications that generate audio streams such as a gaming application that generates audio content for a game, or a conferencing application that generates audio streams corresponding to the voices of remote users. The audio sources may also include system user interface (UI) features for which the electronic device generates audio streams for system UI sounds, such as skeuomorphic sounds of virtual features (e.g., virtual buttons, keyboards, folders, etc.). As shown, the electronic device 100 may include memory 112. The processing circuitry 110 may, in one or more implementations, execute one or more applications, software, and/or other instructions stored in the memory 112 (e.g., to implement one or more of the processes, methods, activities, and/or operations described herein). In one or more implementations, the memory 112 (or other memory at the electronic device 100) may store one or more machine learning models, such as machine learning model(s) 123. The machine learning model(s) 123 may have been trained to perform or more inference operations responsive to inputs, such as inputs from the microphone(s) 106 and/or the sensors 111. As examples, the machine learning model(s) 123 may have been trained to perform any or all of speech recognition, gesture detection, and/or user intent inference, as described herein.

The audio sources may include masking audio sources, such as system-generated audio streams for masking one or more sound-generating components such as fans or motors of the electronic device 100. For example, in FIG. 1, the processing circuitry 110 is also driving the sound-generating component 108. For example, processing circuitry 110 of the electronic device 100, using power from a power source of the electronic device 100 such as a battery of the electronic device, may drive a sound-generating component 108, such as to operate a cooling fan for cooling of the electronic device 100. In one or more implementations, the electronic device 100 may include one or more sensors, such as a thermal sensor or thermistor, which monitors the temperature of one or more components and/or parts of the electronic device 100. The processing circuitry 110 may control the operation of the sound-generating component 108 based, in part, on sensor information from the thermal sensor. For example, the processing circuitry 110 may increase a setting (e.g., a fan speed) of the sound-generating component 108 (e.g., a fan) when the sensor information from the thermal sensor indicates an increase in temperature of the electronic device 100 or an increase in processing power usage of the electronic device 100. In other examples, the sound-generating component 108 may include motor for moving one or more parts (e.g., one or more displays, or one or more lenses) of the electronic device 100 during operation of the electronic device 100 by a user.

As shown in FIG. 1, sound 116 from the sound-generating component 108 may also be received at an car 150 of a user of the electronic device 100 during operation of the sound-generating component 108. In various use cases, the sound of the sound-generating component 108 may be distracting or unpleasant for the user. For example, the sound 116 generated by the sound-generating component 108 is a byproduct (e.g., noise) of the primary function of the sound-generating component 108 (e.g., the sound of a fan whose primary function is to cool the electronic device 100). For this reason, the processing circuitry 110 may generate one or more masking audio streams (e.g., fan blurring, or BLUR Fan (BLURF), audio streams) that, when output by the speakers 102, mask, blur, or otherwise mitigate at least the user's perception of the sound 116 that is heard by the user.

In one or more implementations, the electronic device (e.g., the processing circuitry 110 of FIG. 1) may operate speakers 102 to output the sound 115 (including audio content) in a geometric distribution that is configured to distribute the audio content from various audio sources to various perceived three-dimensional locations, and/or to mitigate the sound 116 of the sound-generating component 108 (e.g., to mitigate a user's perception of the sound 116 while the sound 116 continues to be generated by the sound-generating component 108). For example, as described in further detail hereinafter, the electronic device 100 may obtain (e.g., generate or retrieve from storage) a geometric distribution for an output of the audio content from one or more audio sources.

A geometric distribution for output of audio content may refer to the one or more directions in which in which audio is output from one or more speakers, one or more locations in the physical environment of a device at which sound from multiple speakers constructively interfere (e.g., and create the perception that the sound is being originated at those one or more locations of constructive interference), and/or one or more locations in the physical environment of a device at which sound from multiple speakers destructively interfere (e.g., and create a geometric hole in which the sound from the multiple speakers cannot be heard or is reduced in amplitude). For example, by projecting the sound 115 (e.g., based on user physical characteristics, such as a Head Related Transfer Function or HRTF, of a user of the electronic device, and/or based on environmental physical characteristics such as a three-dimensional map of the physical environment surrounding the electronic device) in one or more directions and/or to generate one or more locations of constructive interference and/or one or more nulls or geometric holes in the geometric distribution of the sound 115 in the physical environment, a user's perception of the sound 115 can include various origination locations of various audio streams, and/or a user's perception of the sound 116 can be masked, blurred, or otherwise mitigated.

It is appreciated that, in one or more implementations, projecting audio content or sound to a location in a physical environment, as described herein, may include operating multiple speakers of an electronic device to project the sound to the ears of a listening user in a way that causes the listening user to perceive the audio content or sound as emanating from that location, even though the sound itself is emanating from the speakers. In one or more implementations, the audio content and/or the geometric distribution for the audio content may be based, at least in part, on the user physical characteristics. In one or more implementations, the audio content and/or the geometric distribution for the audio content may be based, at least in part, on the environmental physical characteristics.

As illustrated in FIG. 2, in one or more implementations, the electronic device 100 may be implemented as a head-mountable display (HMD) device configured to be donned by a user and to provide virtual reality (VR), augmented reality (AR), mixed reality (MR), etc. experiences (e.g., XR experiences). As illustrated in FIG. 2, the electronic device 100 may include a display, such as display unit 202 (e.g., a display assembly), and one or more straps 204 (e.g., connected to and extending from the display unit 202). The straps 204 may form or be a part of a retention assembly configured to wrap around a user's head to hold the display unit 202 against the face of the user.

In one or more implementations, one or more speakers 102 may be mounted to, on, or within one or more of the straps 204. For example, one or more of the straps 204 may define internal strap volumes, which may include or enclose one or more electronic components disposed in the internal strap volumes. In one example, as shown in FIG. 2, a strap 204 on a first side of the display unit 202 can include an electronic component 212. In one example, the electronic component 212 may include one or more of the speakers 102. By positioning one or more speakers on each of the straps 204, the speakers 102 may be arranged at or near an car of a user that is wearing or donning the electronic device 100 in the configuration of FIG. 2, to project sound into the car of the user. For example, the electronic device 100 may include one or more speakers 102 on each of the straps 204 that are coupled to the opposing sides of the display unit 202. In this way, the speakers 102 of the electronic components 212 may be arranged for providing spatialized audio corresponding to one or more audio sources at the electronic device 100. In one or more implementations, the electronic component 212 may also include processing circuitry such as one or more processors. In one or more implementations, additional speakers may be provided (e.g., in earbuds and/or headphones) that are housed separately from the electronic device 100 and that are communicatively coupled to the electronic device 100 to provide spatialized audio in coordination with display content being displayed by the display unit 202 (e.g., and/or in coordination with extra-aural audio content being output by speakers of the electronic components 212).

In at least one example, the electronic device 100 may including an input component 228 (e.g., a button, a dial, or a crown). In at least one example, the input component 228 may be implemented as a crown that is pressable, rotatable, and/or twistable (e.g., to adjust a volume, such as a main volume, of audio output from the electronic device 100). As illustrated in FIG. 2, the electronic device 100 may include one or more cameras 260 (e.g., infrared cameras, visible light cameras, monochrome images, color images, etc.), and/or one or more sensors 262 (e.g., LIDAR sensors, radar sensors, depth sensors, time-of-flight sensors, inertial sensors, accelerometers, gyroscopes, magnetometers, thermistors, and/or other sensors). In one or more implementations, the cameras 260 and/or the sensors 262 may be used to generate a video stream of the physical environment around the electronic device 100 for display by the display unit 202 (e.g., in combination with virtual content overlaid on the video view of the physical environment).

Image data from the cameras 260 and/or sensor data from the sensors 262 may be used to generate a representation (e.g., a three-dimensional representation) of the physical environment. The representation of the physical environment can be used by the electronic device to provide display content and/or spatialized audio content that is perceived, by a user, to originate from, reside within, and/or interact with the physical environment. In one or more other implementations, the display unit 202 may be transparent or partially transparent to allow a direct view of the physical environment (e.g., in combination with virtual content overlaid on the video view of the physical environment). In one or more implementations, the electronic device 100 may be operable (e.g., using the input component 228) to switch from an augmented or mixed reality display environment in which some or all of the physical environment is visible, to a virtual reality display environment in which the user's view of the physical environment is blocked by the display unit 202 and a virtual environment is displayed by the display unit 202.

As shown, the electronic device 100 may include a pair of lenses 222 in one or more implementations. In one or more implementations, the lenses 222 may be aligned with a pair of corresponding display screens (e.g., a pair of arrays of display pixels with associated control circuitry for operating the display pixels), such that, when a user dons the electronic device 100 in the HMD implementation of FIG. 2, the light from the display screens is focused into the eyes of the user in a way that causes display content, displayed on the display screens, to be perceived by the user as being located at various three-dimensional locations, away from the display screens, such as in a three-dimensional virtual environment or in at various three-dimensional locations in a physical environment of the user (e.g., if the display screens also display a view of the physical environment of the user, such as in an augmented or mixed reality environment).

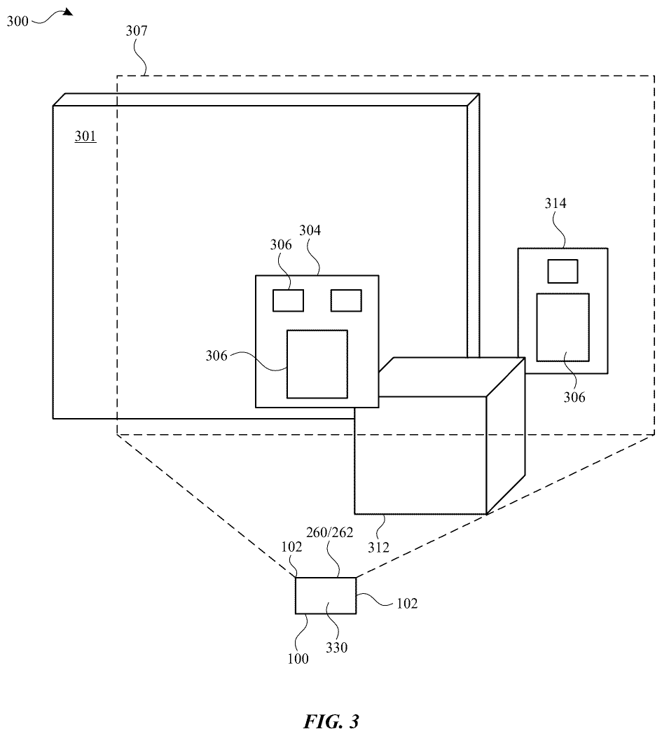

FIG. 3 illustrates an example of a physical environment 300 in which the electronic device 100 may be operated. In the example of FIG. 3, the physical environment 300 includes a physical wall 301 and a physical table 312. As shown, the electronic device 100 (e.g., a display 330 of the electronic device 100, which may be an implementation of the display unit 202) may display virtual content to be perceived by a user viewing the display 330 of the electronic device 100 at various locations in the physical environment 300 that are remote from the electronic device 100. When the virtual content is displayed by the electronic device 100 to cause the virtual content to appear to the user to be in the physical environment 300, the combined physical environment and the virtual content may form an XR environment. In one or more other implementations, the XR environment may be an entirely virtual environment the virtual content displayed in a manner that blocks the user's view of the physical environment 300.

In the example of FIG. 3, the display 330 of electronic device 100 displays a user interface (UI) 304 and a UI 314. For example, the UI 304 may be a UI of a first application (or operating system process) running on the electronic device 100, and the UI 314 may be a UI of a second application (or operating system process) running on the electronic device 100. As shown in FIG. 3, UI 304 and/or UI 314 may include one or more elements 306. Elements 306 may include text entry fields, buttons, selectable tools, scrollbars, menus, drop-down menus, links, plugins, image viewers, media players, sliders, gaming characters, virtual representations of remote user, other virtual content, or the like. Elements 306 may include two-dimensional elements and/or three-dimensional elements. Elements 306 and/or the overall UIs 304 and 314 may be virtual display objects (sometimes referred to herein as objects). Any or all of the elements 306 and/or the overall UIs 304 and 314 may represent audio sources having associated audio streams to be output by the speakers 102 of the electronic device 100.

As shown in FIG. 3, the UI 304 and the UI 314 are displayed in a viewable area 307 of the display 330 of the electronic device 100. As shown, the UI 304 and the UI 314 may be displayed to be perceived by a user of the electronic device 100 (e.g., a viewer of the display 330) at different respective three-dimensional locations and/or distances from the electronic device 100. In the example of FIG. 3, the UI 304 appears to be at a distance that is closer to the electronic device 100 (e.g., and partially in front of a physical table 312 in the physical environment 300) than the apparent distance of the UI 314 (e.g., which may appear partially behind the physical table 312). In one or more other implementations, the XR environment may be an entirely virtual environment in which the UI 304 and the UI 314 are displayed in a manner that blocks the user's view of the physical environment 300 (e.g., over a virtual background display by the display 330 of the electronic device 100).

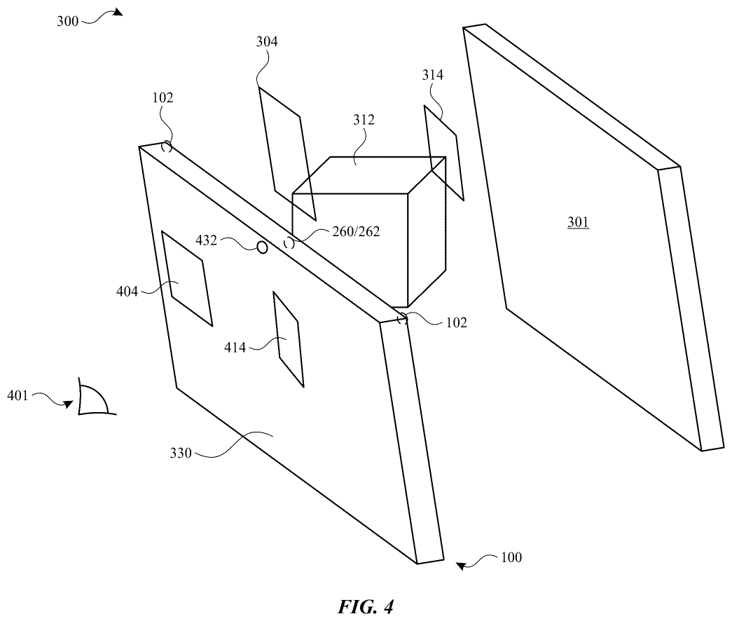

FIG. 4 illustrates a perspective view of the XR environment of FIG. 3. As illustrated in FIG. 4, a representation 404 of the UI 304 may be displayed on the display 330 such that the UI 304 appears to a viewer 401 of the display 330 as if disposed in front of the physical table 312 in the physical environment 300. In this example, a representation 414 of the UI 314 appears to the viewer 401 as if disposed partially behind the physical table 312 in the physical environment 300. FIG. 4 also illustrates how the electronic device 100 may include one or more cameras 432 that face the eyes of the user (e.g., for gaze detection and/or tracking).

In one or more implementations, the electronic device 100 may spatialize one or more audios streams corresponding to one or more of the UI 304, the UI 314, and/or one or more clements 306 thereof, so that audio streams associated with displayed objects are perceived, by the user of the electronic device 100, to be originating from the perceived visual locations of those objects. In accordance with aspects of the subject technology, the volume of an audio stream corresponding to a UI element when that UI element is displayed to be perceived at a first distance may be higher than the volume of that audio stream corresponding to that UI element when that UI element is displayed to be perceived at a second, further distance.

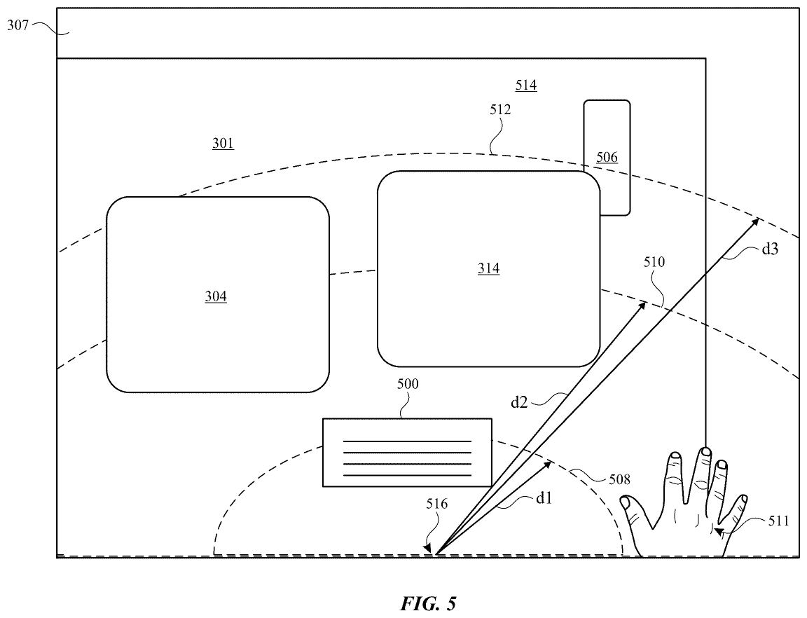

For example, FIG. 5 illustrates an XR environment in which UIs are displayed to be perceived as being at various distances from the user. In the example of FIG. 5, the user interface 500 is displayed in a first distance 508, the user interface 304 and the user interface 314 are displayed at a distance 510, and a user interface 506 is displayed at a distance 512. In the example of FIG. 5, a fourth distance 514 is also indicated. The fourth distance 514 may be, for example, a maximum distance for displayed user interfaces and/or user interface elements, and may be or include a background, backdrop, or ambient layer. In one or more use cases in which the electronic device 100 displays a portion of the physical environment 300, the fourth distance may coincide with the locations of one or more background structures (e.g., the physical wall 301) in the physical environment.

As shown, the first distance 508 may be at a first distance d1 from the location 516 of the electronic device 100 (e.g., and/or the user thereof), the distance 510 may be at a second distance d2, larger than the distance d1, from the location 516 of the electronic device 100 (e.g., and/or the user thereof), and the distance 512 may be a ring of three-dimensional space at a third distance d3, larger than the second distance d2, from the location 516 of the electronic device 100 (e.g., and/or the user thereof).

In one or more implementations, a user of the electronic device 100 may be provided with the ability (e.g., using gestures, such as hand gestures with the user's hand 511) to make adjustments to the distance, orientation, or position (e.g., angular location) of a UI or other displayable object. Although four UIs are shown in FIG. 5 at three distances from the electronic device 100, in other examples, more than four or fewer than four UIs and/or one, two, three, or more than three other displayable objects, can be provided by an electronic device such as the electronic device 100 and more or fewer than three different distances.

In the example, of FIG. 5, the UI 500 represents a system UI, such as a virtual input component for receiving user inputs from the user of the electronic device 100. For example, the UI 500 may be a virtual keyboard whose function is to accept detailed small-scale user inputs (e.g., typing gestures with the user's fingers). In one or more implementations, the electronic device 100 may provide spatialized audio feedback for the UI 500, such as by generating keyboard click sounds that are perceived by the user as originating from the location of keys on the virtual keyboard that are pressed by the user (e.g., virtually pressed, using gestures at the user's perceived location of the UI 500). Other examples of system user interfaces and/or user interface elements that may be displayable at various perceived location include a virtual keypad, a virtual pen or pencil, a virtual board game, or other data entry tools and/or elements.

In one or more implementations, the electronic device 100 may spatialize one or more audio streams corresponding to one or more of the UI 500, the UI 304, the UI 314, the UI 506, and/or one or more elements 306 thereof, so that audio streams associated with displayed Uls are perceived, by the user of the electronic device 100, to be originating from the perceived visual locations of those objects. For example, in one illustrative use case, the UI 304 may be a UI of a messaging application from which alert or notification sounds may originate (e.g., if a user attempts to perform a prohibited action within a document), the UI 314 may be a UI of a conferencing application that is controlling operations of a video conference call with one or more remote users of other electronic devices and from which audio streams corresponding to the voices of the remote user originates, and the UI 506 may be a UI of a media player application from which an audio stream corresponding to music is playing. The electronic device 100 may operate the speakers 102 such that the audio streams of the various applications are spatialized to be perceived by the user as originating from the corresponding UI.

In accordance with aspects of the subject technology, the electronic device 100 may also provide the user with the ability to independently adjust the volume of the audio streams associated with each UI and/or clement thereof. For example, a user may desire to turn down or mute the volume of the alert sounds from the messaging application while conducting a video conference with the conferencing application and listening to music from the media player application. As another example, the user may desire to turn down the volume of the music without turning down the volume of the voices of the remote users in the conferencing application UI. In another example, the user may desire to turn down the volume of the audio streams from all of the active application UIs and/or applications, without turning down the volume of system sounds, such as the virtual clicks of the virtual keyboard.

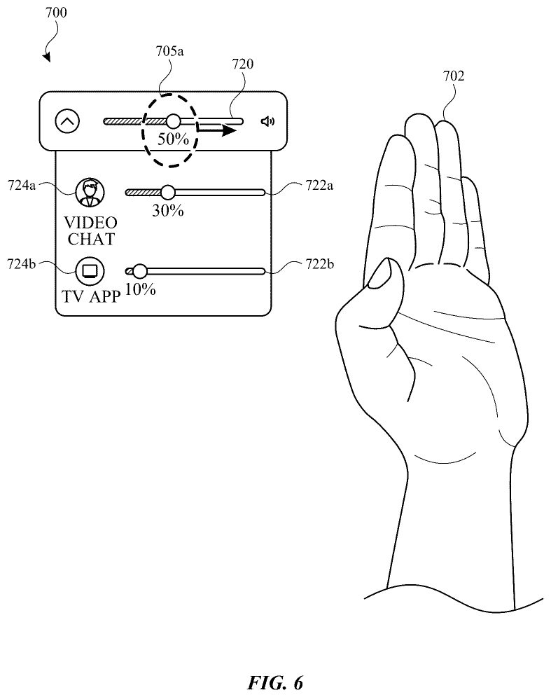

FIG. 6 illustrates an example of a volume control UI 700 that may be provided for allowing a user to independently control the volume of two or more audio streams being generated by the electronic device 100. As shown, the volume control UI 700 may include a main volume control element 720 and one or more individual audio controls, such as volume control element 722a and volume control element 722b. For example, the main volume control element 720 may be controllable by a user to cause the electronic device 100 to adjust a system volume of the electronic device 100. Adjusting the system volume may cause corresponding adjustments to all audio streams being generated by the electronic device, and/or all audio streams except for a set of system audio streams that are non-adjustable (e.g., masking sounds, etc.) as discussed in further detail hereinafter. In one or more implementations, adjusting the main volume control element 720 may set a maximum volume for the individual volume control elements.

Individual volume control elements 722a and 722b may be controls for controlling individual applications, categories of audio sources, environmental sounds, and/or communications (e.g., people and/or communication applications, such as a telephone call, a voice call, an audio conference, or a video conference). In the example of FIG. 6, the volume control element 722a and volume control element 722b are depicted as corresponding to a video chat application and a media output (e.g., television or music) application. As illustrated in FIG. 6, the volume control UI 700 may include an application icon 724a along with the volume control element 722a and an application icon 724b along with the volume control element 722b. In this illustrative example, application icon 724a includes avatar of a person to indicate a video chat application, and the application icon 724b includes an icon that indicates a media output application. In the example of FIG. 6, each of the main volume control element 720, the volume control element 722a, and the volume control element 722b are implemented as virtual sliders that can be moved (e.g., slid) by the user to adjust the relevant volume. The location of the indicator on the slider may indicate a volume control input setting from which the volume of the corresponding audio source can be derived (e.g., using a volume curve). In the example of FIG. 6, a user's hand 702 performs a gesture to provide a user input 705a to move the main volume control element 720 to the right to increase the system volume of the electronic device 100. As one illustrative example, the gesture may be performed by the hand 702 while the user gazes at the main volume control element 720 to select that element for adjustment according to the gesture.

In another example use case, the user may gaze at the volume control element 722a and perform a gesture to slide the corresponding slider to the left or right to decrease or increase the volume of the audio stream from the conferencing application. In another example use case, the user may gaze at the volume control element 722b and perform a gesture to slide the corresponding slider to the left or right to decrease or increase the volume of the audio stream from the media output application. In the example of FIG. 6, the individual volume control elements 722a and 722b each control the volume for a particular application running at the electronic device 100. In one or more other examples, individual volume control elements may be provided for controlling one or more categories of audio source (e.g., an applications category, a voice category, a system sounds category, an environments category, and/or a notifications category), and/or audio sources other than applications.

As discussed in further detail hereinafter, adjusting the individual volume control element for one audio source (or category thereof) may adjust the volume of the corresponding audio stream differently from the way in which adjusting another individual volume control clement adjusts the volume of a different corresponding audio stream. For example, each audio stream (or category thereof) may have a volume that is adjusted according to a corresponding volume curve. For example, a volume curve may indicate an amount of volume change for each of multiple volume input settings (e.g., each of multiple a locations along a slider of a volume control element) and/or may map a hardware volume curve to different software values (e.g., differently mapped for different experiences).

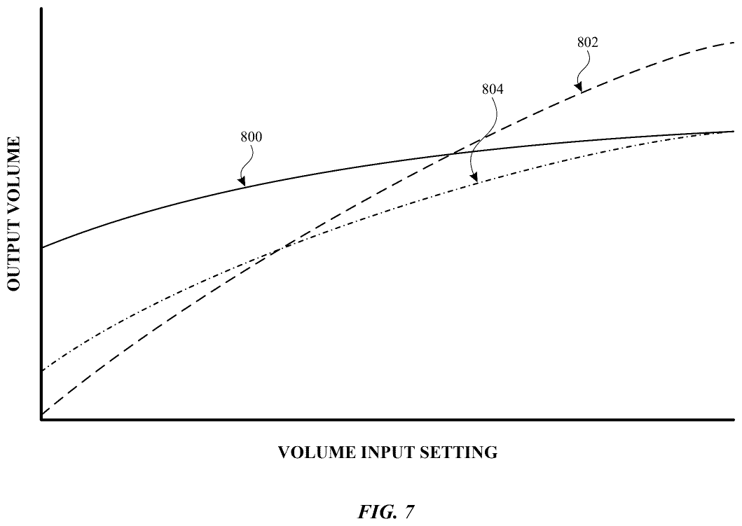

For example, FIG. 7 illustrates examples of volume curves that may be used for various audio sources at an electronic device, such as the electronic device 100. As shown in FIG. 7, a volume curve 800 for a first audio source (e.g., a system audio source, such as a masking sound) may increase the volume of the first audio source at a first (e.g., non-linear) rate with increases in volume input setting (e.g., by sliding a slider of a volume control element up or to the right). As shown, the volume curve 800 may prevent the volume of the first audio source from decreasing below a minimum, non-zero, volume, or from increasing above a maximum volume. In the example of FIG. 7, a separate, different, volume curve 804 may be applied for controlling the volume for a second audio source (e.g., system UI sounds, such as virtual keyboard clicks or other gesture feedback sounds) at the electronic device. In this example, the volume curve 804 for the second audio source increases the output volume at a faster rate with increases in volume input setting than the volume curve 800. As shown, the volume curve 804 may prevent the volume of the second audio source from decreasing below a minimum, non-zero, volume that is lower than the minimum non-zero volume of the volume curve 800, or from increasing above a maximum volume (e.g., the same maximum volume as the volume curve 800).

As shown in FIG. 7, a third, different, volume curve 802 may be applied for controlling the volume for a third audio source (e.g., applications, environmental sounds, voices, etc.) at the electronic device. In this example, the volume curve 802 for the third audio source increases the output volume at a faster rate with increases in volume input setting than the volume curve 800 or the volume curve 804. As shown, the volume curve 802 may allow the volume of the third audio source to decrease to zero (e.g., mute), and/or to increase to a maximum volume that is higher than the maximum volume allowed by the volume curve 800 or the volume curve 804. It is appreciated that the volume curves of FIG. 7 are merely illustrative, and other, more, fewer or different volume curves may be used for adjusting the volume of other, more, fewer or different audio sources (e.g., objects such as displayable objects). For example, volume curves, such as custom volume curves, may be used for each of several different experiences provided by the electronic device 100 (e.g., to map the hardware volume curve to different software values for different experiences). Custom volume curves may be generated by adjusting a minimum volume, a maximum volume, a default volume (e.g., fifty percent), and/or a shape of the volume curve. Mappings that may be applied using the custom volume curves may include linear mappings, logarithmic mappings, exponential mappings, piece-wise mappings, etc. For example, in a use case in which the overall maximum volume output for anything on the device is set to, for example, 85 dBA (e.g., based on a user setting of a main volume for the device), a volume curve for one audio stream or one category of audio streams (e.g., telephony audio streams) may max out at a lower maximum (e.g., 65 dBA), and the corresponding volume curve (e.g., the telephony volume curve) may be mapped accordingly. As another example, the volume curve for alert sounds (e.g., ringtones, message alerts, calendar alerts, or the like) may set a minimum volume (e.g., ten percent of maximum) that is greater than zero.

As discussed herein, a volume curve may apply to a single audio source or object, or may apply to a category or group of audio sources or objects. In the example of FIG. 7, the volume curves 800, 802, and 804 are monotonically increasing exponential curves. However, in other implementations, the volume curves may have other shapes and/or forms (e.g., non-exponential, linear, piecewise defined, etc.).

As discussed herein, the volume of an audio stream may also provide a perceptual audio cue as to the perceived distance of a source of audio. Accordingly, the electronic device 100 may, in one or more implementations, adjust the volume of an audio stream of a particular audio source based on the distance (e.g., distance d1, d2, d3 of FIG. 5) of the corresponding UI or UI element as displayed by the display unit 202 of the electronic device 100. For example, a user may be provided with the ability to move a UI, UI element, or other displayed object from one three-dimensional location to another three-dimensional location, which may be at a different distance from the electronic device 100 and/or the user thereof.

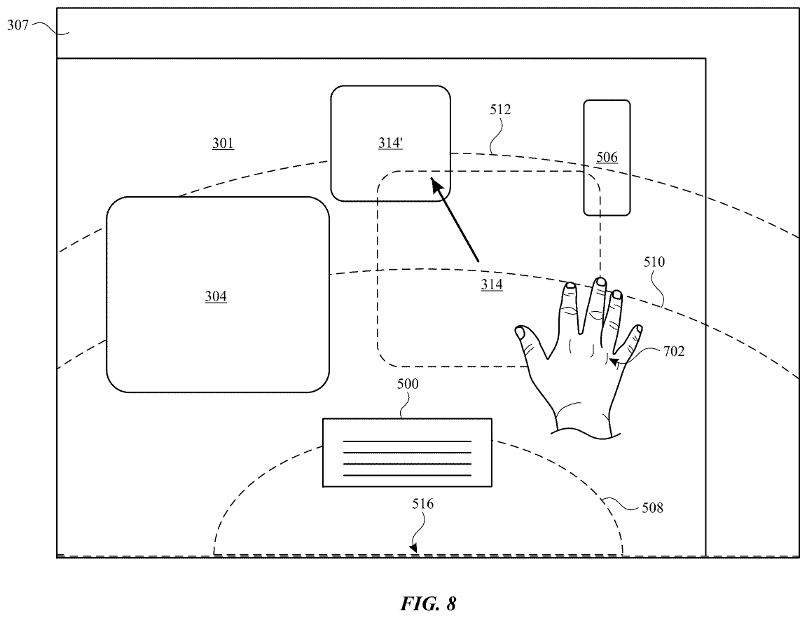

For example, FIG. 8 illustrates an example in which a user performs a gesture (e.g., with the user's hand 702, which may be viewable (e.g., as the hand 511 of FIG. 5 is visible) directly by the user through a portion of the display (e.g., display unit 202) of the electronic device, or which may be a video or virtual image of the user's hand displayed by the display of the electronic device, to move the UI 314 from a distance 510 to a distance 512. As shown, responsive to the user gesture to move the UI 314, the electronic device 100 may move the apparent displayed location of the UI 314 from the distance 510 to the distance 512. As shown, the UI 314 may also be modified to a reduced size UI 314′ responsive to the move from the distance 510 to the distance 512 (e.g., to visually correspond to the physical decrease in perceived size that would occur due to moving of a physical object from the distance 510 to the distance 512 in the physical world). In one or more implementations, the volume of an audio stream corresponding to the UI 314 may also be decreased responsive to the increase in the distance of the displayed location of the UI 314. In one example, the volume may be modified with the distance of the UI according to a physically modeled realistic distance attenuation (e.g., moving a UI or other displayed object further away causes a corresponding audio stream to be reduced in volume, such as proportional to the square of the increase in distance).

In one or more other use cases, the electronic device 100 displaying the UI 314 can make non-physical changes to a UI or UI element with changes in distance, that may, for example, not be made to a physical object (e.g., by increasing the size of the UI or UI element with increasing distance, such as to allow text in the UI to continue to be readable by the user at the increased distance, or by modifying a nearby video window into a virtual movie theater screen tens or hundreds of feet wide). Similarly, the electronic device 100 displaying a UI 314 can make non-physical changes to the volume, tuning, and/or other aspects of an audio stream corresponding to a UI with changes in the displayed distance of the UI.

As one example, in a use case in which a UI or UI element is increased in size when moved further in distance, the volume of the corresponding audio stream for that UI or UI element may increase (e.g., proportional to the increase in size) rather than decreasing with the increase in distance. In one or more other examples, a source volume of the audio stream may be increased (e.g., proportional to an increase in size of a UI or UI element) and then the output volume may be determined based on a physically modeled realistic distance attenuation of the new source volume. For example, a portion of the spatialized audio stream for a UI, UI element, or other displayed object corresponding to a direct audio path from the UI, UI element, or other displayed object to the user may be adjusted in a non-physical manner (e.g., increased), and one or more other portions of the spatialized audio stream (e.g., portions, such as extra-aural portions, of the spatialized audio stream corresponding to reverberations and/or reflections of the audio in the virtual or physical environment) may be adjusted based on the modeled physical behavior of the sound with the increased direct path volume from the increased distance in the currently displayed (e.g., virtual or physical) environment. In one or more other examples of non-physical changes to the volume with distance, the volume of an audio stream corresponding to displayed content may be adjusted in other ways (e.g., non-linear, piecewise, etc.) when the (e.g., perceived) distance to the displayed content changes. In one other example, different physical and/or non-physical distance-volume models may be applied for distance changes within various different distance ranges. For example, for distance changes within a first distance, D (e.g., one meter), from the user or the electronic device, no changes in volume may be applied to the audio stream. In this example, for distance changes in a range between the first distance, D, and a second distance, D′ (e.g., two meters), from the user or the electronic device, N dB (e.g., three dB) of volume reduction may be applied to the audio stream for each doubling of the distance. In this example, for distance changes in a range between the second distance, D′, and a third distance, D″ (e.g., six meters), from the user or the electronic device, M dB (e.g., one dB) of volume reduction may be applied to the audio stream for each doubling of the distance.

In one or more implementations, the electronic device 100 may determine a user intent associated with a user input, and adjust the volume of one or more UI, UI element, or other objects based on the user input and the user intent. For example, the user input may include adjusting a volume control element for a UI, a UI element, or a category of UIs or UI elements. As another example, the user input may include moving a UI or a UI element to a new location or distance. The user intent may be determined by providing the user input and/or one or more additional inputs to one or more machine learning models at the electronic device 100 that have been trained to determine a user intent from a user input (e.g., and/or one or more additional inputs). The additional inputs may include sensor data from one or more of the sensors 262 of the electronic device, and/or inputs derived from the sensor data. As examples, inputs derived from the sensor data may include a gaze location of the user (e.g., a location at which the user's gaze currently falls), a gaze history, an activity history, calendar information, a gesture emphasis factor (e.g., a speed or force of an input gesture), or the like. For example, if the user deliberately moves a UI or UI element from a first distance to a second distance at a relatively slow rate, a machine learning model at the electronic device may indicate a user intent to decrease the volume according to the increase in distance. As another example, if the user aggressively swipes or swats a UI or UI element from its current location (e.g., and/or makes a frustrated noise detectable by one or more microphones of the electronic device, such as a sigh or a grunt, or a verbal utterance, such as “quiet!”, “shut up”, or “get away”), a machine learning model at the electronic device may indicate (e.g., by determining that the user is irritated or frustrated with the audio stream from that UI or UI element) a user intent to decrease the volume more than the increase in distance of the position of the UI or UI element, or to the mute the volume of the UI or UI element.

As another example, a recent gaze history of the user may indicate that a particular set of UIs and/or UI elements (e.g., at which the user has often or repeatedly gazed in a predetermined preceding period of time) may cause a machine learning model at the electronic device to determine a user intent to control the volume(s) of any audio streams corresponding to that set of UIs and/or UI elements together. In this example, the electronic device 100 may dynamically categorize the set of UIs and/or UI elements as a category of UIs or UI elements for which the volume should be adjusted together in response to a user volume control input. As another example, a user listening to music during a video conference with another user may lean in toward a remote user in the video conference during a particular portion of the video conference. The user's lean may be detected by one or more sensors of the electronic device and provided to one or more machine learning models at the electronic device that have been trained to determine a user intent based on user posture and/or user motion. The machine learning model may output a user intent to listen carefully to the remote user, and the electronic device may reduce the volume of the music from the media player application and/or increase the volume of the voice of the remote user responsive to the determined user intent to listen carefully to the remote user.

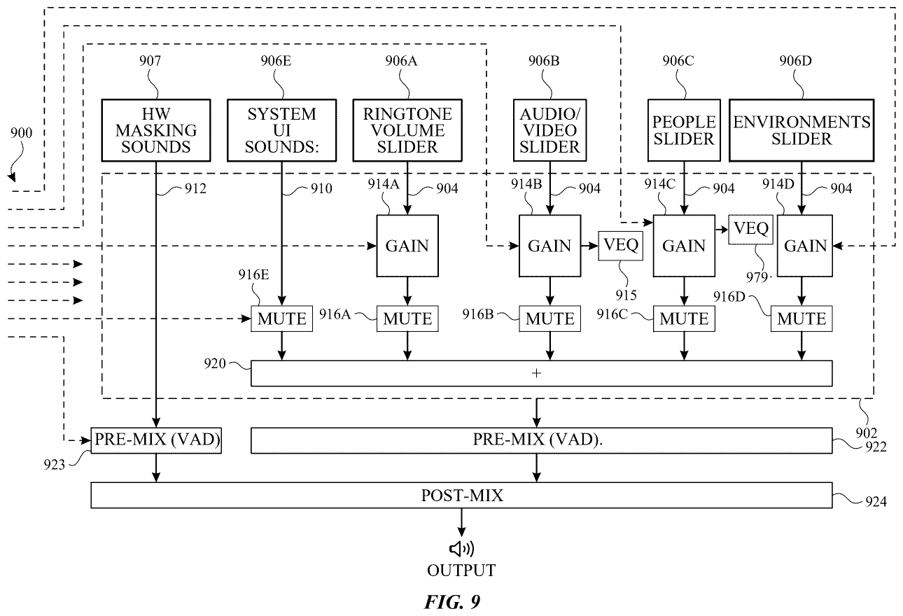

FIG. 9 illustrates a schematic block diagram of an example architecture for providing spatialized volume control, in accordance with one or more implementations. In the example of FIG. 9, multiple audio streams 900 are received at a processing block 902. As examples, the audio streams 900 may include audio streams from various objects that function as audio sources at the electronic device. Objects that function as audio sources at the electronic device may include objects with displayed or displayable virtual objects, such as various UIs and/or UI elements that are displayed or displayable by the electronic device 100 (e.g., using the display unit 202). Objects that function as audio sources at the electronic device may also include notifications (e.g., alerts, ringtones, alarms, or the like), applications, people (e.g., voices of remote users of remote device, such as devices connected to a call or conferencing session with the electronic device 100), and/or environments. Environments may be provided by the electronic device 100 as, for example, three-dimensional virtual backgrounds (e.g., visual and/or spatialized audio backgrounds) within which other objects can be placed and/or interacted with by a user.

Thus, in various examples, the audio streams 900 may include audio streams corresponding UIs and/or UI elements, audio streams corresponding to notifications (e.g., alerts, ringtones, alarms, or the like), audio streams corresponding to audio/video objects (e.g., including applications and/or media content), audio streams corresponding to people (e.g., voices of remote users of remote device, such as devices connected to a call or conferencing session with the electronic device 100), and/or audio streams corresponding to environmental sounds of a particular virtual environment (e.g., an outdoor environment such as a mountaintop environment or a lakeside environment, an indoor environment such as a conference room environment or a movie theater environment) being generated by the electronic device. The audio streams 900 may be provided by one or more applications running at the electronic device and/or one or more system processes (e.g., operating system level processes) at the electronic device. For example, the audio streams 900 may also include audio streams corresponding to system-generated sounds, such as masking sounds (e.g., for masking the sound of a fan, a motor, or other mechanical component at the electronic device), and/or system UI sounds, such as skeuomorphic sounds of a virtual keyboard, button, window or the like. The audios streams 900 may have been spatialized (e.g., to be perceived, upon output by the electronic device 100, as originating from various three-dimensional locations around the user, such as three-dimensional locations at which corresponding display objects are displayed to be perceived by the user) before being provided to the processing block 902 in one or more implementations.

As shown, the processing block 902 may also receive multiple volume control input settings 904 from multiple volume controllers. Volume control input settings 904 may include a volume setting (e.g., a scalar value indicating a volume level or percentage of maximum volume) and/or a mute setting (e.g., for switching on or off the output of a particular audio stream). In one or more implementations, volume controllers, such as volume controllers 906A, 906B, 906C, and 906D may be associated with a displayable volume control element (e.g., volume control element 722a or volume control element 722b) that can be displayed by the electronic device to provide volume control capability to a user for a particular audio source or group or category of audio sources. For example, the volume control elements for the volume controllers 906A, 906B, 906C, and 906D may include virtual sliders, virtual dials, or other virtual control elements that can be controlled by a user via gesture input or input to an input component of the electronic device 100 (e.g., as described herein in connection with FIG. 6). In the example of FIG. 9, each of the volume controllers 906A, 906B, 906C, and 906D is configured to control the volume of a category of audio sources. In other examples, volume controllers may be provided for controlling the volume of individual audio sources.

In the example of FIG. 9, the volume control input settings 904 may include volume control input settings from the volume controller 906A for the notifications, volume control input settings from the volume controller 906B for the audio/video (e.g., applications and/or media) content, volume control input settings from the volume controller 906C for the people or voices, and/or volume control input settings from the volume controller 906D for the environments. As shown, the volume control input setting from the volume controller 906A may be provided to a gain stage 914A. The gain stage 914A may determine a gain to be applied to audio streams in the ringtone category (e.g., alerts, ringtones, alarms) by obtaining a gain value, from a volume curve (e.g., volume curve 800, 802, or 804, or another volume curve) for the ringtone category, which corresponds to the volume input control setting for the ringtone category. The gain stage 914A may then apply that gain value to the notifications audio stream to set the volume of that audio stream. As discussed herein, the volume curve for each category of audio source, or for each individual audio source, may be different from the volume curve of one or more other categories of audio sources, or individual audios sources. In one or more implementations, the volume curve for the ringtone category may have a minimum volume that is greater than zero. As shown, a muting function 916A may also be provided by the processing block 902 for the notifications. For example, the muting function 916A may be controlled by a user (e.g., via a muting element of the volume control clement for the volume controller 906A) to mute the audio streams in the ringtone category.

As shown, the volume control input setting from the volume controller 906B may be provided to a gain stage 914B. The gain stage 914B may determine a gain to be applied to audio streams in the audio/video category (e.g., including applications and/or other media content sources) by obtaining a gain value, from a volume curve (e.g., volume curve 800, 802, or 804, or another volume curve) for the audio/video category, that corresponds to the volume input control setting for the audio/video category. The gain stage 914B may then apply that gain value to the audio/video audio streams to set the volume for those streams. In one or more implementations, the volume curve for the audio/video category may allow the volume to be reduced to zero or may prevent the volume from being reduced to zero. As shown, the processing block 902 may also include a volume-dependent equalizer (EQ) 915 for the audio/video streams in one or more implementations. In one or more implementations, the volume-dependent EQ 915 for the audio/video streams may be implemented using equal loudness contours. For example, performing EQ using an equal loudness contour may modify, responsive to a change in a volume setting, the volume (e.g., loudness) of different frequencies of an audio stream differently to account for the human auditory perception that frequencies played back at the same sound pressure level are not perceived as equal to human hearing, and that at different sound pressure levels, the perceptual gap between the frequencies played back at the same sound pressure level changes. As examples, equal loudness contours may include Fletcher-Munson curves, Robinson and Dadson curves, or the curves specified in International Organization for Standardization (ISO) 226. As shown, a muting function 916B may also be provided by the processing block 902 for the audio/video streams. For example, the muting function 916B may be controlled by a user (e.g., via a muting element of the volume control element for the volume controller 906B) to mute the audio streams in the audio/video category.

As shown, the volume control input setting from the volume controller 906C may be provided to a gain stage 914C. The gain stage 914C may determine a gain to be applied to audio streams in the people category (e.g., people audio streams including voices of remote users in telephony and/or audio and/or video conferencing applications) by obtaining a gain value, from a volume curve (e.g., volume curve 800, 802, or 804, or another volume curve) for the people category, that corresponds to the volume input control setting for the people category. The gain stage 914C may then apply that gain value to the people audio streams. In one or more implementations, the volume curve for the people category may allow the volume to be reduced to zero. As shown, the processing block 902 may also include a volume-dependent equalizer (EQ) 979 for the people audio streams in one or more implementations. In one or more implementations, the volume-dependent EQ 979 may be implemented using equal loudness contours. For example, performing EQ using an equal loudness contour may modify, responsive to a change in a volume setting, the volume (e.g., loudness) of different frequencies of an audio stream differently to account for the human auditory perception that frequencies played back at the same sound pressure level are not perceived as equal to human hearing, and that at different sound pressure levels, the perceptual gap between the frequencies played back at the same sound pressure level changes. As examples, equal loudness contours may include Fletcher-Munson curves, Robinson and Dadson curves, or the curves specified in International Organization for Standardization (ISO) 226. In one or more implementations, volume-dependent EQ 979 that is applied to the people audio streams may be different from the volume-dependent EQ 915 that is applied to the audio/video streams (e.g., the volume-dependent EQ 979 may implement a different equal loudness curve from an equal loudness curve that is implemented by the volume-dependent EQ for audio/video streams). For example, the volume-dependent EQ 979 may be configured to perceptually mimic the human hearing frequency response to other human voices at various different volumes. As another example, the volume-dependent EQ 979 may be configured to boost speech intelligibility at low volumes. As another example, the volume-dependent EQ 979 and/or a separate speech enhancer EQ may be configured to boost speech intelligibility in the presence of high background noise (e.g., at the location of a remote user or at the location of a local user). As shown, a muting function 916C may also be provided by the processing block 902 for the people audio streams. For example, the muting function 916C may be controlled by a user (e.g., via a muting element of the volume control element for the volume controller 906C) to mute the audio streams in the people category.

As shown, the volume control input setting from the volume controller 906D may be provided to a gain stage 914D. The gain stage 914D may determine a gain to be applied to audio streams in the environments category by obtaining a gain value, from a volume curve (e.g., volume curve 800, 802, or 804, or another volume curve) for the environments category, which corresponds to the volume input control setting for the environments category. The gain stage 914D may then apply that gain value to the environments audio streams. In one or more implementations, the volume curve for the environments category may allow the volume to be reduced to zero. As shown, a muting function 916D may also be provided by the processing block 902 for the environments audio streams. For example, the muting function 916D may be controlled by a user (e.g., via a muting element of the volume control element for the volume controller 906D) to mute the audio streams in the environments category.

As shown, the processing block 902 may also receive volume control input settings 910 from a volume controller 906E for system UI sounds. In this example, the processing block 902 may be provided without a gain stage for the system UI sounds, and may be provided with a muting function 916E for the system UI sounds. In one or more implementations, a volume control element associated with the volume controller 906E may include a virtual mute button for muting the feedback sounds of virtual keyboard, or system-generated UI element. For example, a user of the electronic device 100 may be provided with the ability to mute the system UI sounds, without providing the ability to continuously change the volume of the system UI sounds.

As shown in FIG. 9, once the gains and/or muting have been applied to the audio streams 900 by the gain stages 914A, 914B, 914C, and 914D, and/or the muting functions 916A, 916B, 916C, 916D, and 916E, the audio streams 900 for the system UI sounds, the ringtones, the audio/video, the people, and the environments may be combined (e.g., mixed) by a combiner 920 of the processing block 902, to generate an initial mixed audio stream. As shown, the volumes (e.g., gains) and/or mute status of the various audio streams 900 may be set (e.g., by applying a gain determined from a volume curve using a current volume input setting) in parallel before the audio streams are combined by the combiner 920.

As shown in FIG. 9, the initial mixed audio stream may then be pre-processed (e.g., as a single audio stream) by a mixing block 922. For example, the mixing block 922 may apply an equalization (e.g., EQ, such as a personalized overall EQ for a user of the electronic device) to the initial mixed audio stream.

As shown in FIG. 9, volume control input settings 912 for system-generated masking sounds may be set by a volume controller 907. In one or more implementations, the volume controller 907 may be provided without providing a volume control element that is accessible by a user. In this way, the electronic device 100 may ensure that hardware masking sounds (e.g., of which the user may typically be unaware as they mask other, undesirable, sounds) are not inadvertently quicted by a user (e.g., so that the masking sounds are always on, irrespective of the volume of other audio streams at the electronic device). As shown, the audio stream 900 for the masking sounds, and the volume control input settings 912 for the masking sounds, may bypass the processing block 902, and may be provided directly to mixing block 923 for the masking sounds. In one or more implementations, the mixing block 923 may be implemented as a virtual audio device, and may perform equalization and/or tuning operations for the masking audio stream(s).

As shown, once the equalization and/or tuning operations have been applied, in parallel, to the initial mixed audio stream and the masking audio stream(s), the initial mixed audio stream and the masking audio stream(s) may be combined (e.g., by post-mix block 924) to form a mixed audio stream for output by the speakers 102 of the electronic device 100. In one or more implementations, the post-mix block 924 may perform one or more post-mix operations (e.g., speaker protection and/or calibration operations) on the mixed audio stream prior to output of the mixed audio stream.

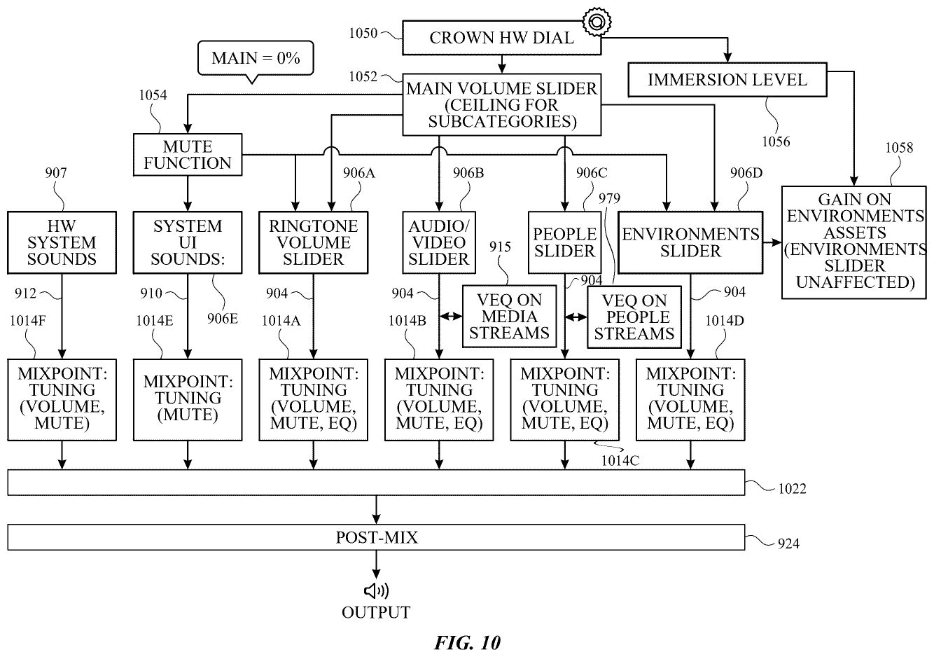

FIG. 10 illustrates a schematic block diagram of another example architecture for providing spatialized volume control, in accordance with one or more implementations. In the example of FIG. 10, the volume input control settings from the volume controllers 906A, 906B, 906C, 906D, 906E, and 907 are provided to individual tuning blocks 1014A, 1014B, 1014C, 1014D, 1014E, and 1014F. In the example of FIG. 10, the respective audio streams (e.g., audio streams 900 as shown in FIG. 9) for the respective categories that are provided to the respective tuning blocks 1014A, 1014B, 1014C, 1014D, 1014E, and 1014F are not shown, for simplicity and readability of the figure.

In this example, the tuning block 1014A may provide the gain and/or muting functions of the gain stage 914A and the muting function 916A of FIG. 9, for the audio streams in the ringtone category. In one or more implementations, the tuning block 1014A may also perform an equalization (EQ), such as a volume-dependent EQ operation on the audio streams in the ringtone category. The tuning block 1014B may provide the gain and/or muting functions of the gain stage 914B and the muting function 916B of FIG. 9, for the audio streams in the audio/video category. In one or more implementations, the tuning block 1014B may also perform an equalization (EQ), such as a volume-dependent EQ operation on the audio streams in the audio/video category.

The tuning block 1014C may provide the gain and/or muting functions of the gain stage 914C and the muting function 916C of FIG. 9, for the audio streams in the people category. In one or more implementations, the tuning block 1014C may also perform an equalization (EQ), such as a volume-dependent EQ operation on the audio streams in the people category. The tuning block 1014D may provide the gain and/or muting functions of the gain stage 914D and the muting function 916D of FIG. 9, for the audio streams in the environments category. In one or more implementations, the tuning block 1014D may also perform an equalization (EQ), such as a volume-dependent EQ operation on the audio streams in the environments category. The tuning block 1014E may provide the muting function of the muting function 916E of FIG. 9, for the audio streams in the system UI sounds category. In one or more implementations, the tuning block 1014E may also perform an equalization (EQ), such as a volume-dependent EQ operation on the audio streams in the system UI sounds category.

In the example of FIG. 10, the tuning block 1014F may providing volume control and/or muting of the masking audio stream(s) (e.g., with or without providing user access to the volume controller 907). As shown in FIG. 10, the tuning blocks 1014A, 1014B, 1014C, 1014D, 1014E, and 1014F may process their respective audio streams, in parallel, prior to mixing of the processed audio streams by a mixing block 1022. Mixing block 1022 may combine the processed audio streams (e.g., processed by the tuning blocks 1014A, 1014B, 1014C, 1014D, 1014E, and 1014F by applying the various respective gains according to respective volume curves, by applying respective muting functions, and/or by applying various EQs) to form a mixed audio stream. The mixing block 1022 may also perform other pre-mix operations, such as applying an equalization (e.g., EQ, such as a personalized overall EQ for a user of the electronic device) to the mixed audio stream. As shown, the mixed audio stream may be further processed by the post-mix block 924, such as by performing one or more post-mix operations (e.g., speaker protection and/or calibration operations) on the mixed audio stream prior to output of the mixed audio stream.

FIG. 10 also illustrates how the electronic device 100 may also provide main volume control settings for the electronic device. For example, the main volume control settings may override any individual and/or category volume control settings, or may govern or set limits on the individual and/or category volume control settings.

In the example of FIG. 10, multiple input mechanisms for controlling the main volume are shown. For example, a user may provide a main volume control setting via a hardware controller 1050 (e.g., hardware crown, dial, button, or other hardware controller). As indicated in FIG. 10, the hardware controller 1050 may also control a virtual main volume controller 1052, such as a virtual slider, dial, button, or the like. In this way, the user may be provided with multiple options (e.g., physical and virtual) for setting the main volume of the electronic device 100. As shown, a main volume control setting (e.g., set via the hardware controller 1050 or the virtual main volume controller 1052) may be provided to the volume controllers 906A, 906B, 906C, and/or 906D. In one or more implementations, the main volume control settings may include a value that sets maximum volume for each of the volume control input setting 904. As indicated in the figure, a main muting function 1054 may also be provided. For example, in a user case in which the main volume control setting is set to zero (e.g., zero percent of maximum system volume) or a mute option is selected, the main muting function 1054 may provide a muting instruction to the volume controller 906A for the ringtones and the volume controller 906E for the system UI sounds. The volume controller 906A and the volume controller 906E may, responsively, provide settings that instruct the tuning blocks 1014A and 1014E to mute the ringtone and system UI audio streams. As shown, the volume controller 907 for the hardware system sounds (e.g., masking sounds) may be independent of the main volume controls in one or more implementations.

FIG. 10 also illustrates how the hardware controller 1050 may (e.g., in another mode of operation for the hardware controller 1050) provide an immersion level (e.g., a value that sets the amount, or percentage, of immersion of the user in a virtual environment, versus passthrough of the physical environment, by the electronic device 100) to an immersion audio controller 1056. As shown, the immersion audio controller 1056 may control a gain stage 1058, for environments audio streams, that is separate from the tuning block 1014D for the environment audio streams. For example, the immersion audio controller 1056 may apply a first gain to the environments audio streams (e.g., without affecting a slider or other audio settings control element for the volume controller 906D) based on the immersion level. For example, the first gain may be increased with increased immersion level. The tuning block 1014D may then apply a second gain to the environments audio streams, based on the volume control input setting 904 received from the volume controller 906D (e.g., based on a user input).

The various controllers and/or blocks described herein may include one or more digital signal processors, machine learning models, and/or other processing circuitry and/or algorithms, and may be implemented in hardware, software, and/or firmware in various implementations.

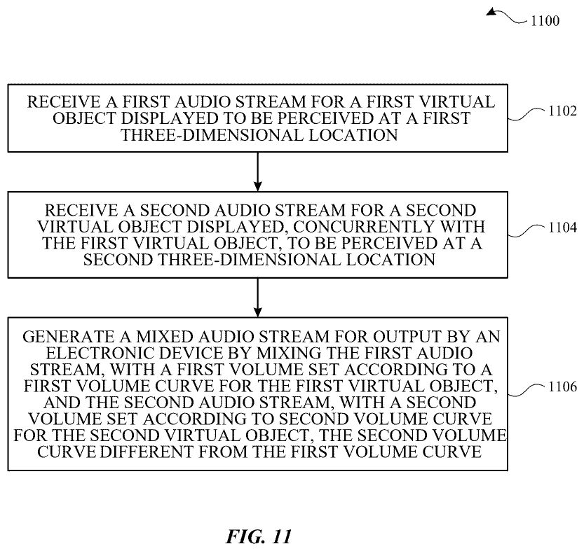

FIG. 11 illustrates a flow diagram of an example process for spatial volume control, in accordance with one or more implementations. For explanatory purposes, the process 1100 is primarily described herein with reference to the electronic device 100 of FIGS. 1-2. However, the process 1100 is not limited to the electronic device 100 of FIGS. 1-2, and one or more blocks (or operations) of the process 1100 may be performed by one or more other components and other suitable devices. Further for explanatory purposes, the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

In the example of FIG. 11, at block 1102, a first audio stream for a first virtual object (e.g., UI 304, UI 314, a UI element 306, a system UI, or other displayable element) displayed to be perceived at a first three-dimensional location (e.g., in the physical environment 300) may be received (e.g., by a processing block, such as processing block 902, at an electronic device, such as the electronic device 100). The first audio stream may be received from an application or a system process at the electronic device.

At block 1104, a second audio stream for a second virtual object displayed, concurrently with the first virtual object, to be perceived at a second three-dimensional location may be received (e.g., by the processing block 902). The second audio stream may be received from another application or system process at the electronic device.

At block 1106, a mixed audio stream may be generated (e.g., by the processing block 902, the post-mix block 924, and/or the mixing block 1022) for output by an electronic device (e.g., the electronic device 100) by mixing the first audio stream, with a first volume set (e.g., by one of the gain stages 914A, 914B, 914C, or 914D, muting functions 916A, 916B, 916C, 916D, or 916E, and/or tuning blocks 1014A, 1014B, 1014C, 1014D, 1014E, or 1014F) according to a first volume curve (e.g., a volume curve such as volume curve 800) for the first virtual object, and the second audio stream, with a second volume set (e.g., by another one of the gain stages 914A, 914B, 914C, or 914D, muting functions 916A, 916B, 916C, 916D, or 916E, and/or tuning blocks 1014A, 1014B, 1014C, 1014D, 1014E, or 1014F) according to second volume curve (e.g., a different volume curve such as volume curve 804) for the second virtual object, the second volume curve different from the first volume curve.

For example, the first volume curve may indicate an amount of volume change (e.g., an amount of gain change) for each of a plurality of volume input settings, as described herein in connection with FIG. 7). The second volume curve may indicate a different amount of volume change for each of the plurality of volume input settings. The plurality of volume input settings may include a plurality of scalar values indicating a volume level or a percentage of a maximum volume level, in one or more implementations.

In one or more implementations, prior to the mixing, the first volume of the first audio stream may be adjusted (e.g., by one of the gain stages 914A, 914B, 914C, or 914D, muting functions 916A, 916B, 916C, 916D, or 916E, and/or tuning blocks 1014A, 1014B, 1014C, 1014D, 1014E, or 1014F) according to the first volume curve for the first virtual object, and a second volume of the second audio stream may be adjusted (e.g., by another one of the gain stages 914A, 914B, 914C, or 914D, muting functions 916A, 916B, 916C, 916D, or 916E, and/or tuning blocks 1014A, 1014B, 1014C, 1014D, 1014E, or 1014F) according to the second volume curve for the second virtual object. For example, adjusting the first volume may include adjusting the first volume responsive to a first user input (e.g., via a first volume control element in a volume control user interface, such as a virtual slider or virtual knob) corresponding to the first virtual object, and adjusting the second volume may include adjusting the second volume responsive to a second user input (e.g., via a second volume control element in the volume control user interface, such as a virtual slider or virtual knob) corresponding to the second virtual object.

In one or more implementations, a third user input (e.g., via a third volume control element, such as a main volume control element 720 for the electronic device) for adjusting a volume of an audio output of the electronic device may be received, and a third volume of the mixed audio stream may be adjusted (e.g., by yet another one of the gain stages 914A, 914B, 914C, or 914D, muting functions 916A, 916B, 916C, 916D, or 916E, and/or tuning blocks 1014A, 1014B, 1014C, 1014D, 1014E, or 1014F).

In one or more implementations, the first volume curve corresponds to a first category of audio sources at the electronic device, the first category including the first virtual object and not the second virtual object, and the second volume curve corresponds to a second category of audio sources at the electronic device, the second category including the second virtual object and not the first virtual object. In one illustrative example, the first category may include applications at the electronic device and the second category may include system-generated sounds at the electronic device. The system-generated sounds may include system UI sounds and/or masking sounds (e.g., system hardware sounds). In one or more implementations, the first audio stream may be muted, and the second audio stream may be prevented from being muted.

In one or more implementations, a change may be detected (e.g., by the electronic device 100) in a distance, from the electronic device, of the first three-dimensional location, and the electronic device may perform, based on the change in the distance, a non-physical adjustment of a volume of a first portion of an audio output that is based on the first audio stream. For example, the non-physical adjustment of the volume of the first portion may include increasing the volume when the distance of first three-dimensional location increases. As another example, the non-physical adjustment of the volume of the first portion may include decreasing the volume of the first portion as the distance of first three-dimensional location increases, by less than a decrease that would occur for the volume of a physical sound source undergoing the same increase in distance. As another example, the non-physical adjustment of the volume of the first portion may include decreasing the volume when the distance of first three-dimensional location decreases. As another example, the non-physical adjustment of the volume of the first portion may include increasing the volume of the first portion, as the distance of first three-dimensional location decreases, by less than an increase that would occur for the volume of a physical sound source undergoing the same decrease in distance.

The electronic device may also perform, based on the change in the distance and the non-physical adjustment, a physics-based adjustment of a volume of a second portion (e.g., an extra-aural portion) of the audio output that is based on the first audio stream. For example, the physics-based adjustment may include, starting with the volume of the first audio stream set according to the non-physical adjustment, modifying the perceptual reflections and/or reverberations of the first audio stream according to a three-dimensional physical model of the physical or virtual environment in which the first object is displayed (e.g., the source volume may be set in a non-physical manner, and the behavior of the sound with the non-physical source volume may be physics based).

In one or more implementations, adjusting the first volume may include modifying a volume of a first frequency of the first audio stream by a first amount determined using the first volume curve, and adjusting a second volume of a second frequency of the first audio stream by a second amount, wherein the second amount is different from the first amount by a difference amount that depends on the first amount. For example, in one or more implementations, an equalization (EQ) or frequency dependent gain that is applied to the first audio stream may be volume dependent (e.g., different EQs, such as different equal loudness contours) may be used at different volume settings). For example, when a user input to adjust the volume of a particular virtual object is received, one or more of the frequencies of the audio stream from that virtual object may be modified by the amount indicated in the user input (e.g., or by an amount obtained from a volume curve using the user input), and other frequencies of that audio stream may be modified differently according to a volume dependent EQ that is obtained according to the user's new volume setting.

In one or more implementations, setting the first volume may include applying (e.g., by a first gain stage of the gain stages 914A, 914B, 914C, and 914D of the processing block 902, or by a first one of the tuning blocks 1014A, 1014B, 1014C, 1014D, 1014E, or 1014F) a first gain, determined from the first volume curve to the first audio stream prior to the mixing. Adjusting the second volume may include applying (e.g., by a second gain stage of the gain stages 914A, 914B, 914C, and 914D of the processing block 902, or a second one of the tuning blocks 1014A, 1014B, 1014C, 1014D, 1014E, or 1014F) a second gain, different from the first gain and determined from the second volume curve to the second audio stream prior to the mixing.

In one or more implementations, the first audio stream may be spatialized (e.g., by appropriately distributing the first audio stream across multiple speakers on both sides of the user's head), to be perceived to originate at the first three-dimensional location, prior to adjusting the first volume. The second audio stream may also be spatialized (e.g., by appropriately distributing the first audio stream across multiple speakers on both sides of the user's head), to be perceived to originate at the second three-dimensional location, prior to adjusting the second volume.

In one or more implementations, the process 1100 may also include determining (e.g., by one or more machine learning models 123), based on sensor data from one or more sensors (e.g., sensors 111, camera(s) 260, and/or sensor(s) 262) at the electronic device, a user intent associated with the request to modify the volume. The process 1100 may also include setting the first volume according to the first volume curve based at least in part on the user intent, and setting the second volume according to the second volume curve based at least in part on the user intent. For example, setting a volume according to volume curve based at least in part on a user intent may include selecting or modifying the volume curve (e.g., to increase or decrease the volume more rapidly or more slowly with changing user inputs and/or display distances) based on the user intention.

For example, the electronic device may determine that a user has pushed a displayed user interface away from them with a force, speed, or audible expression that indicates frustration with the sound originating from that user interface. In this example, the volume of the sound originating from that user interface may be decreased rapidly (e.g., at a high rate of volume change per change in distance) with increasing distance of the displayed location of that user interface. In contrast, if the same user picks and places the same user interface at a further distance without any indication of frustration being detected by the electronic device, the volume of the sound originating from that user interface may decrease more slowly (e.g., with a lower rate of volume change per change in distance) with increasing distance that in the use cases of a frustrated push.

As another example, when a user pushes a user interface away from them while their gaze is located on that user interface, the volume may be decreased more slowly (e.g., with a lower rate of volume change per change in distance) than when the user pushes the user interface away from them while their gaze is not located on that user interface. In this way, the user's intention with respect to how much they desire the volume of the sound from a particular displayed object to change can be inferred by an electronic device and used by the electronic device to change the volume according to the user's intent.

As another example, setting one or more volumes based on a user intent may include dynamically categorizing various audio sources at the electronic device, for joint volume control, according to the user intent.

In one or more implementations, the process 1100 may also include dynamically adjusting the first audio stream based on a background noise in a physical environment of the electronic device (e.g., to perform a speech enhancement of a telephony stream in the presence of the background noise), and set the first volume of the first audio stream according to the first volume curve for the first virtual object and according to the dynamically adjusting of the first audio stream based on the background noise (e.g., to mitigate counteracting an effect of the dynamically adjusting based on the background noise with the setting of the first volume using the first volume curve).

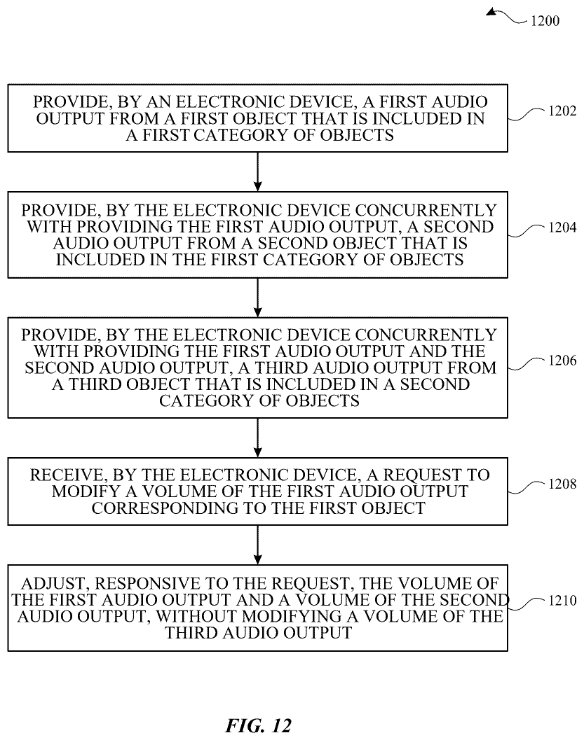

FIG. 12 illustrates a flow diagram of another example process for spatial volume control, in accordance with one or more implementations. For explanatory purposes, the process 1200 is primarily described herein with reference to the electronic device 100 of FIGS. 1-2. However, the process 1200 is not limited to the electronic device 100 of FIGS. 1-2, and one or more blocks (or operations) of the process 1200 may be performed by one or more other components and other suitable devices. Further for explanatory purposes, the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

In the example of FIG. 12, at block 1202, an electronic device (e.g., electronic device 100) may provide a first audio output from a first object (e.g., UI 304, UI 314, a UI element 306, a system UI, or other displayable element) that is included in a first category of objects. For example, providing the first audio output may include providing a first spatialized audio output to be perceived as originating from a first location (e.g., a first distance and a first angular location) in a physical environment. For example, the first object may include a first display object that is displayed, by the electronic device, to be perceived at the first location in the physical environment.

At block 1204, the electronic device may provide, concurrently with providing the first audio output, a second audio output from a second object (e.g., another of the UI 304, the UI 314, the UI element 306, the system UI, or other displayable element) that is included in the first category of objects. For example, providing the second audio output may include providing a second spatialized audio output to be perceived as originating from a second location (e.g., a second distance and a second angular location) in the physical environment.

At block 1206, the electronic device may provide, concurrently with providing the first audio output and the second audio output, a third audio output from a third object that is included in a second category of objects. For example, providing the third audio output may include providing a third spatialized audio output to be perceived as originating from a third location (e.g., a third distance and a third angular location) in the physical environment. In one illustrative example, the first category of objects may include application user interfaces and the second category of objects may include media output sources. In another example, the first category of objects may include voices of remote users, and the second category of objects may include environmental sounds. In another example, the first category of objects may include environmental sounds, and the second category of objects may include system-generated sounds, such as masking sounds and/or system UI sounds.

At block 1208, the electronic device may receive a request to modify a volume of the first audio output corresponding to the first object. For example, the request may be a user request. The user request may be provided via a volume control element (e.g., a virtual slider, dial, or button, such as the volume control element 722a or the volume control element 722b) corresponding to a volume controller (e.g., one of volume controllers 906A, 906B, 906C, 906D, or 906E).

At block 1210, the electronic device may adjust, responsive to the request, the volume of the first audio output and a volume of the second audio output (e.g., in the same first category, such as by a corresponding one of the gain stages 914A, 914B, 914C, or 914D, muting functions 916A, 916B, 916C, 916D, or 916E, and/or tuning blocks 1014A, 1014B, 1014C, 1014D, 1014E, or 1014F), without modifying a volume of the third audio output. Adjusting the volume of the first audio output and the volume of the second audio output may include adjusting the volume of the first audio output and the volume of the second audio output based on a volume curve for the first category.

In one or more implementations, prior to the adjusting, the electronic device may determine, based on sensor data from one or more sensors (e.g., camera(s) 260 and/or sensor(s) 262) at the electronic device, a user intent associated with the request to modify the volume; associate, based at least in part on the user intent, the first object and the second object with the first category of objects; and associate, based at least in part on the user intent, the third object with the second category of objects. In this way, the displayed objects and/or other sources of sound at the electronic device can be dynamically categorized for volume control based on the intent of the user in one or more implementations. For example, the user intent may be determined by providing the sensor data to one or more machine learning models (e.g., machine learning model(s) 123 at the electronic device) that have been trained (e.g., by adjusting one or more weights and/or other parameters associated with one or more nodes of a neural network based on comparisons of training outputs, generated by the one or more machine learning models responsive to receiving training sensor data as training inputs, with known training intents of prior users) to infer an intent of a user.

Dynamically categorizing displayed objects and/or other sources of sound may include categorizing the displayed objects and/or other sources of sound into a system masking sounds category, a system UI sounds category, a ringtones category, an audio/video category, a people category, and/or an environments category, as in the examples of FIGS. 9 and 10. In another example, dynamically categorizing displayed objects and/or other sources of sound may include categorizing a subset of multiple displayed UIs or UI elements in one category (e.g., based on a frequency and/or a recency of the user's engagement with that subset of the UIs or UI elements), and another subset of the multiple displayed UIs or UI elements into another, different category (e.g., based on a lower frequency and/or less recency of the user's engagement with that subset of the UIs or UI elements). In another example, dynamically categorizing displayed objects and/or other sources of sound may include assigning one or more active and/or inactive sources of sound that the user commonly uses together (e.g., a music application, a word processing application, and a conferencing application) into a category for volume control, and assigning one or more other active and/or inactive sources of sound that the user commonly uses together (e.g., a fitness application, a podcasts application, and a telephony application) into another category for volume control.

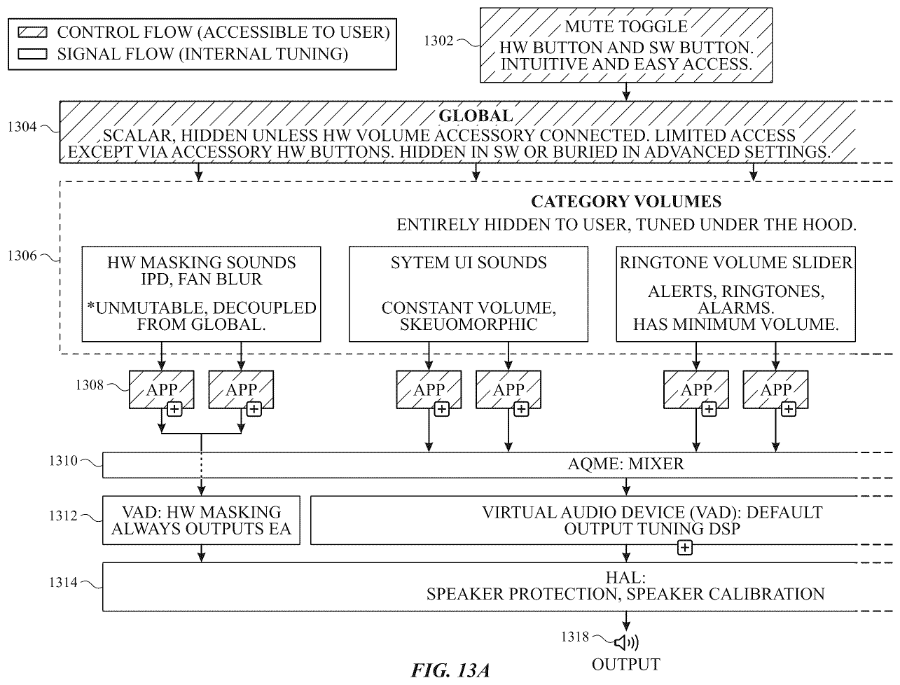

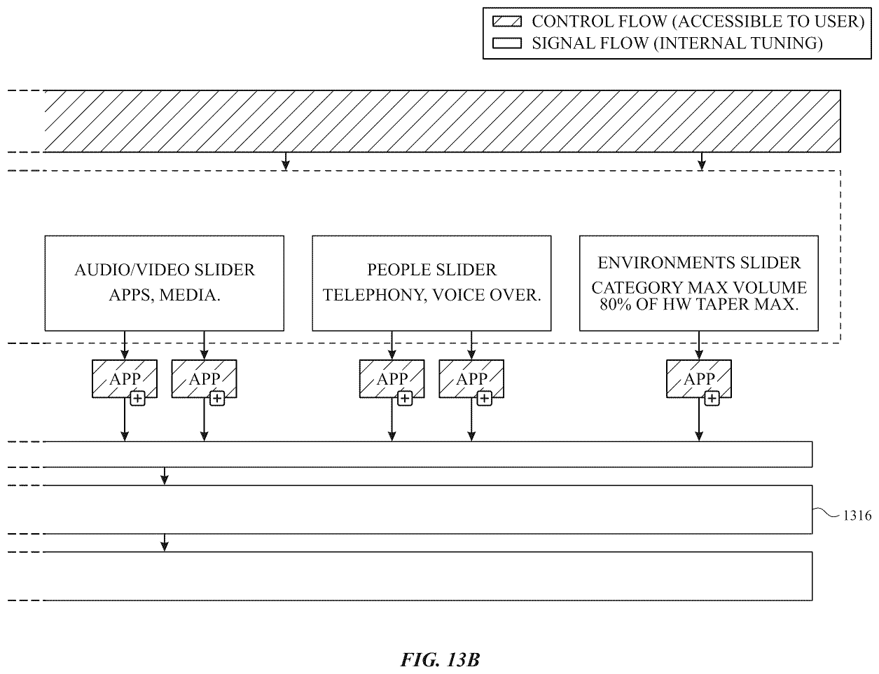

FIGS. 13A-B illustrate an example top-down architecture 1300 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The architecture 1300 includes a global volume level 1304, with a mute control 1302 as a binary toggle on the global volume, a category volume level 1306, an application volume level 1308, a mixer level 1310 (e.g., referred to as an AQME: MIXER in the figure, which may be an implementation of the processing block 902 of FIG. 9), a virtual audio device module 1312 (e.g., which may be an implementation of the mixing block 922), a virtual audio device output tuning module 1316 (e.g., which may be an implementation of the mixing block 923), a hardware abstraction layer 1314, and an output 1318 (e.g., by one or more speakers, such as speaker 102 of FIG. 1).

In one or more implementations, the top-down architecture 1300 represents one or more volume or gain stages with different options as to exposure of user-facing control. For example, in one or more implementations, only a global mute toggle and per-application (“app”) sliders may be surfaced with the exception of allowing global volume to be driven by a hardware volume device, such as a Bluetooth device incapable of software volume control when connected.

Referring to the global volume level 1304 (“global”), global may function as a true main volume for every volume category in the default virtual audio device (however, not any other virtual audio devices such as hardware masking sounds). In one or more implementations, global may function as a scalar on all of its volume categories, and global may be a software volume abstraction that, for example, correlates 1:1 to device hardware volume. In one or more implementations, global may be hidden and/or difficult to access by a user. For example, global may not be an easily accessible hardware slider or dial. In one or more implementations, global may be displayed in advanced settings, or it may be displayed temporarily while adjusting volume via an auxiliary Bluetooth device that is only hardware-volume capable, or it may be hidden entirely.

Referring to the category volume level 1306, the category volume level 1306 may include volume curves and/or volume-dependent EQ on categories such as, for example, telephony, media, apps, ringtones, alerts, system UI sounds, environments, and the like. The category volume level 1306 may be opaque to the user and may represent, for example, a stage of volume curves, but with no user control. In one or more implementations, the volume curves may be custom volume curves, mapping the incoming global or hardware volume curves to different software curves. The custom category curves may have different minimum, maximum, and/or default volume levels from the global and/or hardware volume curve.

In one or more implementations, the custom category curves may have different curve shapes, such as logarithmic, exponential, linear, and/or piecewise. The different categories may have different DSP tunings. For example, the media category may apply a normalization or media EQ tuning to one or more or all of its subscribed apps. The people category may apply a voice EQ to one or more or all of its subscribed apps. In one or more implementations, hardware masking sounds may go through their own virtual audio device and be uncuttable, so substantially never affected by global volume, mute toggle, and/or the connection of an auxiliary Bluetooth device.

Referring to the app volume level 1308, (“per-app volume”), the per-app volume may apply an attenuation curve (e.g., relative to a higher-level category volume, which may be user-adjustable or user-opaque) on one or more or all streams within an app. Each app may expose a user-controllable input to its volume attenuation curve, to the user, via a user interface (“UI”). In one or more implementations, a volume slider may be hosted alongside the chrome controls of each app. In one or more implementations, a list of volume sliders may be displayed (e.g., together in a volume-control user interface, which may include a main volume slider and/or an environments volume slider) for active audio apps. The perceived output volume may be the result of a calculation that combines multiple volume control values (e.g., a main or global volume value, a category volume value, and/or an app volume value, which may be obtained from an app-specific volume curve based on a user-controllable app-volume input value as discussed herein) into a final volume value. This final volume value for each app may be used to set the gain that is applied to the audio stream for that app, and/or may be provided as an input to one or more dynamic processing blocks (e.g., a volume-dependent EQ block, a speech enhancement EQ block, or the like) that process the audio stream for that app. In some implementations, the calculation of the final volume value may be a product of multiple input volume values (e.g., Final volume=Global volume*Category volume*App volume). In other implementations, a more complex calculation may be performed to obtain the final volume value. For example, a calculation block may be provided (e.g., for each application) that collects multiple input volume values and/or streams for an app, maps those input values, for example, onto one or more device volume curves, and/or onto a relational percentage of volume or a final dBA value (e.g., using one or more mapping curves, which may be linear, logarithmic, piecewise, or custom) to generate the final volume value.

In some implementations, the calculation block may be provided in the audio processing chain of an audio stream (e.g., within the mixer level 1310) for an app (e.g., such that the calculation block receives an audio stream, applies one or more mapping curves to the audio stream based on the input volume values, and outputs an adjusted audio stream to a subsequent processing stage). In one or more other implementations, the calculation block may be provided outside the audio processing chain of an audio stream for an app (e.g., along-side of, and in communication with, the mixer level 1310). For example, the calculation block may take one or more volume scalar values (e.g., corresponding to the input volume values) as inputs from the mixer level 1310, apply the one or more mapping curves to the one or more volume scalar values to generate an output volume value, and provide the output volume value back to the mixer level 1310 to apply to the audio stream and/or to inform one or more dynamic processing blocks that are also applied to the audio stream.

The volume-dependent EQ may be applied (e.g., in the mixer level 1310) per stream for apps subscribing to a category that enables volume-dependent EQ. For example, media as a category may enable volume-dependent EQ, while a music stream and a TV stream may each have volume-dependent EQ. In one or more implementations, telephony as a category enables volume-dependent EQ. For example, in a call with three other participants, each of the three telephony streams may receive an instance of volume-dependent EQ. The volume-dependent EQ gain setting may be a result of (Global volume*Category volume*App volume), in order to apply proper EQ compensation to gain adjustment. For example, the final downstream gain on a stream (e.g., as determined by a calculation block as discussed above) may be what drives its EQ setting.

As discussed in connection with the examples of FIGS. 9, 10, 13A, and 13B, audio streams from each of several applications and/or other audio sources at an electronic device may have individual volume settings and/or individual volume-based processing (e.g., individual volume curves, muting, and/or individual volume-dependent EQ) applied thereto. It is appreciated that volume-based processing and/or other processing of the individual audio streams (e.g., and/or volume-based processing and/or other processing of downstream combined/mixed audio streams) may be informed by inputs and/or outputs of the other volume-based processing of that stream, and/or inputs and/or outputs of the volume-based processing of other audio streams. For example, for people audio streams (e.g., audio streams associated with telephony, such as for phone calls, audio conferences, video conferences, or the like) a speech enhancer may be applied that adjusts the frequency of a people audio stream in response to background noise. This speech enhancer operation may be performed in tandem with a volume dependent EQ operation (e.g., volume-dependent EQ 979 of FIG. 9 and/or FIG. 10), which adjusts the volumes of various frequencies of the people audio stream based on a setting of a user-provided volume slider (e.g., without considering the background noise). In one or more implementations, these multiple dynamic processing blocks (e.g., the speech enhancer and the volume-dependent EQ) may receive, as inputs, the same source audio stream, as well as information corresponding to the processing of the other dynamic processing block(s). For example, one or more (e.g., each) of the multiple dynamic processing blocks may include logic that accounts for the operations of the other processing block(s) (e.g., so that the multiple processing blocks don't unintentionally counteract each other, such as in a use case in which there is a high background noise and the user has set the telephony volume to a high volume).

As described above, one aspect of the present technology is the gathering and use of data available from specific and legitimate sources for processing user information in association with providing spatial volume control for electronic devices. The present disclosure contemplates that in some instances, this gathered data may include personal information data that uniquely identifies or can be used to identify a specific person. Such personal information data can include voice data, speech data, audio data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for spatial volume control for electronic devices. Accordingly, use of such personal information data may facilitate transactions (e.g., on-line transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of spatial volume control for electronic devices, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data.

FIG. 14 illustrates an electronic system 1400 with which one or more implementations of the subject technology may be implemented. The electronic system 1400 can be, and/or can be a part of, one or more of the electronic device 100 shown in FIG. 1. The electronic system 1400 may include various types of computer readable media and interfaces for various other types of computer readable media. The electronic system 1400 includes a bus 1408, one or more processing unit(s) 1412, a system memory 1404 (and/or buffer), a ROM 1410, a permanent storage device 1402, an input device interface 1414, an output device interface 1406, and one or more network interfaces 1416, or subsets and variations thereof.

The bus 1408 collectively represents all system, peripheral, and chipset buses that communicatively connect the numerous internal devices of the electronic system 1400. In one or more implementations, the bus 1408 communicatively connects the one or more processing unit(s) 1412 with the ROM 1410, the system memory 1404, and the permanent storage device 1402. From these various memory units, the one or more processing unit(s) 1412 retrieves instructions to execute and data to process in order to execute the processes of the subject disclosure. The one or more processing unit(s) 1412 can be a single processor or a multi-core processor in different implementations.

The ROM 1410 stores static data and instructions that are needed by the one or more processing unit(s) 1412 and other modules of the electronic system 1400. The permanent storage device 1402, on the other hand, may be a read-and-write memory device. The permanent storage device 1402 may be a non-volatile memory unit that stores instructions and data even when the electronic system 1400 is off. In one or more implementations, a mass-storage device (such as a magnetic or optical disk and its corresponding disk drive) may be used as the permanent storage device 1402.

In one or more implementations, a removable storage device (such as a floppy disk, flash drive, and its corresponding disk drive) may be used as the permanent storage device 1402. Like the permanent storage device 1402, the system memory 1404 may be a read-and-write memory device. However, unlike the permanent storage device 1402, the system memory 1404 may be a volatile read-and-write memory, such as random access memory. The system memory 1404 may store any of the instructions and data that one or more processing unit(s) 1412 may need at runtime. In one or more implementations, the processes of the subject disclosure are stored in the system memory 1404, the permanent storage device 1402, and/or the ROM 1410. From these various memory units, the one or more processing unit(s) 1412 retrieves instructions to execute and data to process in order to execute the processes of one or more implementations.

The bus 1408 also connects to the input and output device interfaces 1414 and 1406. The input device interface 1414 enables a user to communicate information and select commands to the electronic system 1400. Input devices that may be used with the input device interface 1414 may include, for example, alphanumeric keyboards and pointing devices (also called “cursor control devices”). The output device interface 1406 may enable, for example, the display of images generated by electronic system 1400. Output devices that may be used with the output device interface 1406 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 14, the bus 1408 also couples the electronic system 1400 to one or more networks and/or to one or more network nodes, through the one or more network interface(s) 1416. In this manner, the electronic system 1400 can be a part of a network of computers (such as a LAN, a wide area network (“WAN”), or an Intranet, or a network of networks, such as the Internet. Any or all components of the electronic system 1400 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving a first audio stream for a first virtual object displayed to be perceived at a first three-dimensional location;
receiving a second audio stream for a second virtual object displayed, concurrently with the first virtual object, to be perceived at a second three-dimensional location; and
generating a mixed audio stream for output by an electronic device by mixing the first audio stream, with a first volume set according to a first volume curve for the first virtual object, and the second audio stream, with a second volume set according to a second volume curve for the second virtual object, the second volume curve different from the first volume curve.

2. The method of claim 1, wherein the first volume curve indicates an amount of volume change for each of a plurality of volume input settings, and wherein the second volume curve indicates a different amount of volume change for each of the plurality of volume input settings.

3. The method of claim 1, further comprising:
adjusting, prior to the mixing, the first volume of the first audio stream according to the first volume curve for the first virtual object; and
adjusting, prior to the mixing, the second volume of the second audio stream according to the second volume curve for the second virtual object.

4. The method of claim 3, wherein adjusting the first volume comprises adjusting the first volume responsive to a first user input corresponding to the first virtual object, and wherein adjusting the second volume comprises adjusting the second volume responsive to a second user input corresponding to the second virtual object.

5. The method of claim 4, further comprising:
receiving a third user input for adjusting a volume of an audio output of the electronic device; and
adjusting a third volume of the mixed audio stream.

6. The method of claim 1, wherein the first volume curve corresponds to a first category of audio sources at the electronic device, the first category including the first virtual object and not the second virtual object, and wherein the second volume curve corresponds to a second category of audio sources at the electronic device, the second category including the second virtual object and not the first virtual object.

7. The method of claim 6, wherein the first category comprises applications at the electronic device and wherein the second category comprises system-generated sounds at the electronic device.

8. The method of claim 7, further comprising:
muting the first audio stream, and
preventing muting of the second audio stream.

9. The method of claim 1, further comprising:
detecting a change in a distance, from the electronic device, of the first three-dimensional location; and
performing, based on the change in the distance, a non-physical adjustment of a volume of a first portion of an audio output that is based on the first audio stream; and
performing, based on the change in the distance and the non-physical adjustment, a physics-based adjustment of a volume of a second portion of the audio output that is based on the first audio stream.

10. The method of claim 1, further comprising adjusting the first volume by:
modifying a volume of a first frequency of the first audio stream by a first amount determined using the first volume curve; and
adjusting a volume of a second frequency of the first audio stream by a second amount, wherein the second amount is different from the first amount by a difference amount that depends on the first amount.

11. The method of claim 1, further comprising setting the first volume by applying a first gain determined from the first volume curve to the first audio stream prior to the mixing, and adjusting the second volume by applying a second gain, different from the first gain and determined from the second volume curve to the second audio stream prior to the mixing.

12. The method of claim 11, further comprising:
spatializing the first audio stream to be perceived to originate at the first three-dimensional location prior to adjusting the first volume; and
spatializing the second audio stream to be perceived to originate at the second three-dimensional location prior to adjusting the second volume.

13. A method, comprising:
providing, by an electronic device, a first audio output from a first object that is included in a first category of objects;
providing, by the electronic device concurrently with providing the first audio output, a second audio output from a second object that is included in the first category of objects;
providing, by the electronic device concurrently with providing the first audio output and the second audio output, a third audio output from a third object that is included in a second category of objects;
receiving, by the electronic device, a request to modify a volume of the first audio output corresponding to the first object; and
adjusting, responsive to the request, the volume of the first audio output and a volume of the second audio output, without modifying a volume of the third audio output.

14. The method of claim 13, wherein providing the first audio output comprises providing a first spatialized audio output to be perceived as originating from a first location in a physical environment, wherein providing the second audio output comprises providing a second spatialized audio output to be perceived as originating from a second location in the physical environment, and wherein providing the third audio output comprises providing a third spatialized audio output to be perceived as originating from a third location in the physical environment.

15. The method of claim 14, wherein the first object comprises a first display object that is displayed, by the electronic device, to be perceived at the first location in the physical environment.

16. The method of claim 15, wherein the first category of objects comprises application user interfaces and wherein the second category of objects comprises media output sources.

17. The method of claim 13, further comprising, prior to the adjusting:
determining, based on sensor data from one or more sensors at the electronic device, a user intent associated with the request to modify the volume;
associating, based at least in part on the user intent, the first object and the second object with the first category of objects; and
associating, based at least in part on the user intent, the third object with the second category of objects.

18. A processor, configured to:
receive a first audio stream for a first virtual object displayed to be perceived at a first three-dimensional location;
receive a second audio stream for a second virtual object displayed, concurrently with the first virtual object, to be perceived at a second three-dimensional location; and
generate a mixed audio stream for output by an electronic device by mixing the first audio stream, with a first volume set according to a first volume curve for the first virtual object, and the second audio stream, with a second volume set according to a second volume curve for the second virtual object, the second volume curve different from the first volume curve.

19. The processor of claim 18, wherein the first volume curve indicates an amount of volume change for each of a plurality of volume input settings, and wherein the second volume curve indicates a different amount of volume change for each of the plurality of volume input settings.

20. The processor of claim 18, wherein the processor is further configured to:
adjust, prior to the mixing, the first volume of the first audio stream according to the first volume curve for the first virtual object; and
adjust, prior to the mixing, the second volume of the second audio stream according to the second volume curve for the second virtual object.

21. The processor of claim 18, wherein the processor is further configured to:
dynamically adjust the first audio stream based on a background noise in a physical environment of the electronic device, and
set the first volume of the first audio stream according to the first volume curve for the first virtual object and according to the dynamically adjusting of the first audio stream based on the background noise.
